(19) United States
(12) Patent Application Publication
(10) Pub. No.: US 2014/0021374 A1
(43) Pub. Date: Jan. 23, 2014

(54) POWER SOURCES

(71) Applicant: XYLECO, INC., Woburn, MA (US)

(72) Inventors: Marshall MEDOFF, Brookline, MA (US); Thomas Craig MASTERMAN, Brookline, MA (US); Kenny Kin-Chui IP, Freemont, CA (US)

(21) Appl. No.: 13/943,167

(22) Filed: Jul. 16, 2013

Related U.S. Application Data
(60) Provisional application No. 61/672,377, filed on Jul. 17, 2012.

(51) Int. Cl. H02M 5/458; G21K 5/00

(52) U.S. Cl. CPC H02M 5/458; G21K 5/00
USPC 250/492.3; 363/37

(57) ABSTRACT

Methods and systems are described for providing a high frequency high voltage source. For example, a power source for use in a particle accelerator, an arc welder or an inductive heater.

### RELATED APPLICATIONS

This application claims priority to U.S. Provisional Application Ser. No. 61/672,377 filed Jul. 17, 2012, the entire disclosure of which is hereby incorporated by reference herein.

### BACKGROUND

Power sources modulate input currents and voltages providing an altered input current and voltage. Such power sources can be used to power equipment, e.g., equipment used for processing materials and equipment used for processing data (e.g., computers). Due to intrinsic energy dissipation, providing efficient and versatile power sources for new or established applications remains a challenge.

### SUMMARY

This invention relates to methods and systems (e.g., circuits) for modulating an input voltage and current to produce a modulated output voltage and current with high efficiency. For example, the methods and systems can produce a frequency of at least about 1 KHz (e.g., at least about 5 KHz, at least about 10 KHz, at least about 20 KHz, at least about 40 KHz, at least about 60 KHz, at least about 80 KHz, at least about 90 KHz at least about 100 KHz, or at least about 150 KHz) and voltages of more than about 1MV (e.g., more than about 2 MV, more than about 5MV, more than about 10 MV, more than about 15MV, more than about 20 MV, more than about 50 MV, or more than about 100 MV) and with efficiencies of at about least 60% (e.g., at least about 70%, at least about 80%, at least about 81%, at least about 82%, at least about 83%, at least about 84%, at least about 85%, at least about 86%, at least about 87%, at least about 88%, at least about 89%, at least about 90%, or at least about 95%). The circuits and method can be used, for example, in systems for arc welding, inductive heating and particle accelerators, for example as a power source.

The invention also relates to using a power source (e.g., that provides a combined high frequency high voltage current) to power a particle beam, e.g., an ion beam or an electron beam accelerator used for processing carbohydrate-containing materials (e.g., biomass feedstocks), such as starchy materials, cellulosic materials, lignocellulosic materials, or biomass materials. The invention also relates to intermediates and products resulting from such processing, such as a molecule (e.g., an antibiotic, an amino acid or an acid), a protein (e.g., an enzyme or a peptone), a sugar (e.g., glucose, xylose or erythritol), a fuel (e.g., ethanol, isobutanol, n-butanol or a hydrocarbon), or mixtures or combinations of any of these. Such power sources can be also used to drive X-Ray generation equipment, e.g., Bremsstralung Generators.

In one aspect of a method invention, the invention features a power supply method for producing a combined high frequency high voltage current. The method includes providing a first DC current in parallel to a first Insulated Gate Biopolar Transistor (IGBT) and a second IGBT. A first AC voltage output from the first IGBT is stepped up producing a first high frequency high voltage current. A second AC voltage output from the second IGBT is stepped up producing a second high frequency high voltage current. The first and the second high frequency high voltage currents can then be combined in series to produce the combined high frequency high voltage current. The method can also include a first AC voltage source that is provided to a first AC to DC converter (e.g., a bridge rectifier) to produce the first DC current.

In another aspect of the invention, the invention can also include providing a second DC current in parallel to a third IGBT and optionally a fourth IGBT. A third AC voltage output from the third IGBT is stepped up producing a third high frequency high voltage current. A fourth AC voltage output from the fourth IGBT is stepped up producing a fourth high frequency high voltage current. The first, second, third and optionally fourth high frequency high voltage currents can be combined in series to produce the combined high frequency, high voltage current. The second DC current supplied to the third and optional fourth IGBT can be produced from a second AC voltage source provided to a second AC to DC converter.

In another aspect of the invention, the invention can also include providing a third DC current in parallel to a fifth IGBT and optionally a sixth IGBT. The fifth AC voltage output from the fifth IGBT is stepped up producing a fifth high frequency high voltage current. The sixth AC voltage output from the sixth IGBT is stepped up producing a sixth high frequency high voltage current. The first, second, third, fourth, fifth and optionally sixth high frequency high voltage currents can be combined in series to produce the combined high frequency, high voltage current. The third DC current supplied to the fifth and optional sixth IGBT can be produced from a third AC voltage source provided to a third AC to DC converter.

In yet another aspect of the invention, the invention can further include the synchronous switching of each of the Insulated Gate Bipolar Transistor (IGBT) components that are used via a synchronous pulse generator coupled to each IGBT (e.g., providing a synchronous gate voltage to the first IGBT, the second IGBT, the third IGBT, the fourth IGBT, the fifth IGBT, the sixth IGBT in any combination). Optionally, the DC currents provided to the IGBT are identical (e.g., with the same electrical characteristics), for example having similar or equivalent collector emitter cut-off current, similar or equivalent gate emitter leakage current, similar or equivalent collector emitter saturation voltage, similar or equivalent gate emitter threshold voltage, similar or equivalent input capacitance, similar or equivalent internal gate resistance, similar or equivalent switching times (e.g., similar or equivalent rise time, similar or equivalent turn on time, similar or equivalent fall time, similar or equivalent turn off time), similar or equivalent peak forward voltage drop, similar or equivalent reverse recovery time, similar or equivalent turn on loss, similar or equivalent turn off loss, similar or equivalent reverse recovery loss and similar or equivalent thermal resistance) and the AC currents produced from the IGBT are therefore identical (e.g., same in shape and frequency).

Optionally to the methods, when two or more AC voltage sources are used, voltage sources can be out of phase with respect to each other for example, 120 degree out of phase with respect to each other. The out of phase voltage source can have the same voltage, for example the same average or root mean square (RMS) voltage. The voltage of the combined high frequency high voltage current can be at least about 2 times (e.g., at least about 5 times, at least about 10 times, at least about 50 times or at least about 100 times) the voltage of the two or more phase, AC source, for example when the voltage sources have the same voltage.

In some aspects of the method, the AC voltage output from any IGBT (e.g., the first, the second, the third, the fourth, the fifth, and/or the sixth IGBT in any combination) can be stepped up by at least about a factor of 2 (e.g., at least about a factor of 3, at least about a factor of 4, at least about a factor of 5, at least about a factor of 6, at least about a factor of 10, at least about a factor of 20, or a least about a factor of 100) in providing the high frequency high voltage current.

Additionally to the method, any one of the DC currents (e.g., the first DC current, the second DC current and/or the third DC current) can be filtered prior to being provided to the corresponding IGBT (e.g., the first IGBT, the second IGBT, the third IGBT, the fourth IGBT, the fifth IGBT and/or the sixth IGBT).

In a further aspect, the invention can be a power supply method for producing a combined high frequency high voltage current using a plurality of elements as outlined herein. An AC input voltage having a plurality of output phases is provided to a plurality of AC to DC converters each accepting one of the pluralities of output phases and producing a plurality of output DC currents. The plurality of output DC currents are provided to a plurality of IGBT switching elements, each accepting the output of a corresponding one of the plurality of AC to DC converters and producing a plurality of output AC currents. Subsequently, the plurality of output AC currents are provided to a plurality of high frequency step up elements each accepting an AC voltage output of a corresponding one of the plurality of IGBT switching elements. Finally, the high frequency high voltage current output from each of the plurality of high frequency step up elements are combined, in series, to produce the combined high frequency high voltage current. Optionally, the plurality of output phases includes three phases and the plurality of IGBT switching elements includes six groups. In some aspects, the combined high frequency high voltage current is at least about 2 times (e.g., at least about 5 times, at least about 10 times, at least about 50 times or at least about 100 times) the AC input voltage. In other aspects, the AC voltage output from any IGBT is stepped up by a factor of at least about 2 (e.g., at least about 3, at least about 4, at least about 5, at least about 6, at least about 8 or at least about 10) in providing the corresponding high frequency high voltage current. Optionally, the DC currents provided to the IGBT are identical (e.g., with similar or equivalent voltage, current, decay rates, growth rates and shape) and the AC currents produced from the IGBT are also identical.

In yet another aspect, the invention can feature a power supply method for producing a combined high frequency high voltage current. The method includes providing a first DC current in parallel to a first IGBT, a second IGBT and a third IGBT. A first AC voltage output from the first IGBT is stepped up producing a first high frequency high voltage current. A second AC voltage from the second IGBT is stepped up producing a second high frequency high voltage current. A third AC voltage from the third IGBT is stepped up producing a third high frequency high voltage current. The first, the second and the third high frequency high voltage currents are then combined in series to produce the combined high frequency high voltage current. Optionally, the method includes providing an AC current to a first voltage control and rectification circuit and a first filter to provide the first DC current. Optionally, the DC currents provided to the IGBT are identical (e.g., with the similar or equivalent voltage, current, decay rates, growth rates and shape) and the AC currents produced from the IGBT are also identical.

Optionally the method can include providing a second DC current in parallel to a fourth IGBT, a fifth IGBT and a sixth IGBT. A fourth AC voltage output from the fourth IGBT is stepped up producing a fourth high frequency high voltage current. A fifth AC voltage output from the fifth IGBT is stepped up producing a fifth high frequency high voltage current. A sixth AC voltage output from the sixth IGBT is stepped up producing a sixth high frequency high voltage current. The high frequency high voltage currents (e.g., from the outputs of IGBTs one through six) are combined in series to produce a combined high frequency high voltage current. Optionally, the method includes providing an AC current to a second voltage control and rectification circuit and a second filter to provide the first DC current.

Optionally the method can include providing a third DC current in parallel to a seventh IGBT, an eighth IGBT and a ninth IGBT. A seventh AC voltage output from the seventh IGBT is stepped up producing a seventh high frequency high voltage current. An eighth AC voltage output from the eighth IGBT is stepped up producing an eighth high frequency high voltage current. A ninth AC voltage output from the ninth IGBT is stepped up producing a ninth high frequency high voltage current. The high frequency high voltage currents (e.g., from the outputs of IGBTs one through nine) are combined in series to produce a combined high frequency high voltage current. Optionally, the method includes providing an AC current to a third voltage control and rectification circuit and a third filter to provide the first DC current.

The method can also include synchronous switching of each IGBT using a synchronous pulse generator coupled to each IGBT.

Yet another aspect of the invention is a power supply method for producing a combined high frequency voltage current. The method includes providing an AC input voltage having a plurality of output phases to a plurality of voltage control and rectification circuits each accepting one of the plurality of output phases and producing a plurality of output DC currents. Additionally, the method includes providing the plurality of output DC currents to a plurality of IGBT switching elements each accepting the output of a corresponding one of the plurality of voltage control and rectification circuits an producing a plurality of output AC currents. The method further includes providing the plurality of output AC currents to a plurality of high frequency step up elements each accepting an AC voltage output from each of the plurality of IGBT switching elements. In the method, the high frequency high voltage current outputs from each of the plurality of high frequency step up elements are combined in series to produce the combined high frequency high voltage current. Optionally the plurality of output phases includes three phases and the plurality of IGBT switching elements include nine groups. Optionally, the DC currents provided to the IGBT are identical (e.g., with the same voltage, current, decay rates, growth rates and shape) and the AC currents produced from the IGBT are also identical.

In one aspect of the power supply method for producing a combined high frequency high voltage current, the method includes providing an AC input voltage having a plurality of output phases to a plurality of AC to DC control circuits. Each AC to DC control circuits can accept at least one of the plurality of output phases and these each produce a plurality of output DC currents. A plurality of IGBT switching elements are provided, each accepting the output of a corresponding one of the plurality of AC to DC control circuits and producing a plurality of output AC currents. The plurality of output AC currents are provided to a plurality of high frequency step up elements. The output high frequency high voltage from the plurality of step up elements are combined in series to produce the combined high frequency high voltage current. The AC to DC control circuits can include one or more Variacs, one or more AC to DC converter (e.g., a bridge rectifier) one or more filtering elements and one or more voltage control or rectification circuits (e.g., including silicon control rectifiers). The IGBT switching can be synchronized by coupling to a synchronous pulse generator.

In one aspect of the inventive system, the circuit relates to a power supply for producing a combined high frequency high voltage current that can include the following. A first DC current source connected in parallel to an input of a first IGBT and an input of a second IGBT. The circuit can also include, a first electrical connection from an output of the first IGBT to a first electrical circuit element for stepping up a first AC voltage output to produce a first high frequency high voltage current and a second electrical connection from an output of the second IGBT to a second electrical circuit element for stepping up a second AC voltage output to produce a second high frequency high voltage current. Finally, the circuit can include an in-series connection of each electrical circuit element for combining the first and the second high frequency high voltage current. Optionally, the power supply can include a first AC voltage source in electrical connection with a first AC to DC converter for producing the first DC current source.

In another aspect of the inventive system, the power supply can include additional components as outlined here. A second DC current source connected in parallel to an input of a third IGBT and an input of a fourth IGBT. A third electrical connection from an output of the third IGBT to the third electrical circuit element for stepping up a third AC voltage to produce a third high frequency high voltage current. A fourth electrical connection from an output of a fourth IGBT to a fourth electrical circuit element for stepping up a fourth AC voltage to produce a fourth high frequency high voltage current. Finally, the power supply can include an in-series connection of each electrical circuit element for combining the first, second, third and fourth high frequency high voltage current. Optionally, the power supply can include a second AC voltage source in electrical connection with a second AC to DC converter for producing the second DC current source.

In yet another aspect of the system, the power supply can include additional components as outlined here. A third DC current source connected in parallel to an input of a fifth IGBT and an input of a sixth IGBT. A fifth electrical connection from an output of the fifth IGBT to the fifth electrical circuit element for stepping up a fifth AC voltage to produce a fifth high frequency high voltage current. A sixth electrical connection from an output of a sixth IGBT to a sixth electrical circuit element for stepping up a sixth AC voltage to produce a sixth high frequency high voltage current. Finally, the power supply can include an in-series connection of each electrical circuit element for combining the first, second, third, fourth, fifth and sixth high frequency high voltage current. Optionally, the power supply can include a third AC voltage source in electrical connection with a third AC to DC converter for producing the third DC current source.

Optionally the one or more of the electrical circuit elements for stepping an AC voltage (e.g., the first, second, third, fourth, fifth and/or sixth AC voltage) can be an inductively coupled transformer.

Optionally, the power source can further include a synchronous pulse generator coupled to each IGBT in use for providing synchronous switching of each IGBT (e.g., providing a synchronous gate voltage to the first IGBT, the second IGBT, the third IGBT, the fourth IGBT, the fifth IGBT and/or the sixth IGBT in any combination).

In options where two or more AC voltage sources are used, the power supply can include a phase shifting circuit element for providing the first AC voltage source out of phase with respect to the second AC voltage source. For example, the phase shifting element can provide a 120 degree phase difference between the AC voltages. The power supply can also include a circuit for providing an equal power to any two or more of the AC voltage sources.

In other aspects of the system, the invention relates to a power supply for producing a combined high frequency high voltage current with a plurality of elements as described here. The power supply includes an AC input voltage providing a plurality of output phases and a plurality of AC to DC converters each accepting one of the plurality of output phases. Furthermore, the power supply has a plurality of IGBT switching elements each accepting an output of a corresponding one of the plurality of AC to DC converters and a plurality of high frequency step up elements each accepting an AC voltage output of a corresponding one of the plurality of IGBT switching elements. The power supply also has a summation element for combining a high frequency high voltage current output from each of the plurality of high frequency step up elements. Optionally the plurality of output phases include three phases and the plurality of IGBT switching elements include six groups. The power supply can include a synchronous pulse generator coupled to the plurality of IGBT switching elements, to provide synchronous switching of the plurality of IGBT switching elements. Furthermore, the power supply can include a plurality of DC filtering circuits coupled to the output of each of the AC to DC converters. In some embodiments the plurality of high frequency step up elements includes an inductively coupled transformer.

In yet another aspect of the system, the invention is a power supply for producing a combined high frequency high voltage current. The power supply includes a first DC current source connected in parallel to an input of a first IGBT, an input of a second IGBT and an input of a third IGBT. The power supply can also include a first electrical connection from an output of the first IGBT to a first electrical circuit element for stepping up a first AC voltage output to produce a first high frequency high voltage current. The power supply can also include a second electrical connection from an output of the second IGBT to a second electrical circuit element for stepping up a second AC voltage output to produce a second high frequency high voltage current. The power supply can further include a third electrical connection from an output of the third IGBT to a third electrical circuit element for stepping up a third AC voltage output to produce a third high frequency high voltage current. The power supply also includes an in-series connection of each step up electrical circuit element for combining the first, the second and the third high frequency high voltage current. Each electrical circuit element for stepping up the voltage can be an inductively coupled transformer. Optionally the power supply includes a first AC voltage source in electrical connection with a first voltage control and rectification circuit and a first filter for producing the first DC current source.

Optionally, the power supply includes a second DC current source connected in parallel to an input of a fourth IGBT, an input of a fifth IGBT and an input of a sixth IGBT. The power supply can also include a fourth electrical connection from an output of the fourth IGBT to a fourth electrical circuit element for stepping up a fourth AC voltage output to produce a fourth high frequency high voltage current. The power supply can also include a fifth electrical connection from an output of the fifth IGBT to a fifth electrical circuit element for stepping up a fifth AC voltage output to produce a fifth high frequency high voltage current. The power supply can further include a sixth electrical connection from an output of the sixth IGBT to a sixth electrical circuit element for stepping up a sixth AC voltage output to produce a sixth high frequency high voltage current. The power supply also includes an in-series connection of each electrical circuit element for combing the high frequency high voltage currents (e.g., the first through sixth high frequency high voltage currents) producing a combined current. Each electrical circuit element for stepping up the voltage can be an inductively coupled transformer. Optionally the power supply includes a second AC voltage source in electrical connection with a second voltage control and rectification circuit and a second filter for producing the first DC current source.

Optionally, the power supply includes a third DC current source connected in parallel to an input of a seventh IGBT, an input of an eighth IGBT and an input of a ninth IGBT. The power supply can also include a seventh electrical connection from an output of the seventh IGBT to a seventh electrical circuit element for stepping up a seventh AC voltage output to produce a seventh high frequency high voltage current. The power supply can also include an eighth electrical connection from an output of the eighth IGBT to an eighth electrical circuit element for stepping up an eighth AC voltage output to produce an eighth high frequency high voltage current. The power supply can further include a ninth electrical connection from an output of the ninth IGBT to a ninth electrical circuit element for stepping up a ninth AC voltage output to produce a ninth high frequency high voltage current. The power supply also includes an in-series connection of each electrical circuit element for combing the high frequency high voltage currents (e.g., the first through ninth high frequency high voltage currents) producing a combined current. Each electrical circuit element for stepping up the voltage can be an inductively coupled transformer. Optionally the power supply includes a third AC voltage source in electrical connection with a third voltage control and rectification circuit and a third filter for producing the first DC current source.

In another aspect of the system, the invention includes a power supply for producing a combined high frequency high voltage current. For example the frequency can be at least about 1 KHz (e.g., at least about 5KHz, at least about 10 KHz, at least about 20 KHz, at least about 40 KHz, at least about 60 KHz, at least about 80 KHz). The power supply can include an AC input voltage providing a plurality of output phases and a plurality of voltage control and rectification circuits accepting at least one of the plurality of output phases. The power supply can also include a plurality of IGBT switching elements each accepting an output of a corresponding one of the plurality of voltage control and rectification circuits. The power supply can further include a plurality of high frequency step up elements each accepting an AC voltage output of a corresponding one of the plurality of IGBT switching elements. Finally, the power supply can include a summation element for combining a high frequency high voltage current output from each of the plurality of high frequency step up elements. Optionally, in this power supply, the plurality of output phases includes three phases and the plurality of IGBT switching elements include nine groups and a synchronous pulse generator coupled to the plurality of IGBT switching elements, to provide synchronous switching of the plurality of IGBT switching elements. The power supply can also include a plurality of DC filtering circuits coupled to the output of each of the plurality of voltage control and rectification circuits.

In yet another aspect the system, the invention is a power supply for producing a combined high frequency high voltage current. The power supply includes an AC input voltage providing a plurality of output phases and a plurality of AC to DC control circuits each accepting at least one of the plurality of output phases. The power supply also includes a plurality of IGBT switching elements each accepting an output of a corresponding one of the plurality of AC to DC converters. The power supply includes a plurality of high frequency step up elements each accepting an AC voltage output of a corresponding one of the plurality of IGBT switching elements. The power supply also includes a summation element for combining a high frequency high voltage current output from each of the plurality of high frequency step up elements. The AC to DC control circuits can include one or more Variacs, one or more AC to DC converter (e.g., a bridge rectifier) one or more filtering elements and one or more voltage control and rectification circuits (e.g., including silicon control rectifiers).

The invention can also relate to biomass processing, for example the invention relates to methods for processing biomass material including providing a combined high frequency high voltage current to a particle accelerator, accelerating a plurality of particles and irradiating the biomass material with the accelerated particles (e.g., irradiating with a particle beam). Optionally the method includes two or more particle accelerators and/or two or more particles beams. Optionally the biomass can be irradiated with at least about 0.25 Mrad of radation (e.g., at least about 0.25 Mrad, ate least about 1.0 Mrad, at least about 2.5 Mrad, at least about 5 Mrad or at least about 10 Mrad) or from 1 about 1 to 100 Mrad (e.g., about 5-50 Mrad, about 10-40 Mrad).

In some cases the particle accelerator is an electron beam accelerator, for example, used to accelerate a plurality of electrons and provide an electron beam. Optionally the electron beam accelerator can have an operating power of at least about 1 KW (e.g., at least about 2 KW, 3 KW, 4 KV, 5KW, 10 KW, 20 KW, 50 KW, 100 KW, 250 KW, or 500 KW or even 1000 KW) and optionally the operating efficiency of the electron accelerator is at least about 60% (e.g., at least about 70%, at least about 80%, at least about 81%, at least about 82%, at least about 83%, at least about 84%, at least about 85%, at least about 86%, at least about 87%, at least about 88%, at least about 89%, at least about 90%, or at least about 95%).

The combined high frequency high voltage current can be supplied by any of the methods discussed herein using any one of the systems described herein. For example, a plurality of elements can be used in a method as outlined here: (1) an AC input voltage having a plurality of output phases is provided to a plurality of AC to DC converters (or a plurality of voltage control and rectification circuits) each accepting one of the pluralities of output phases and producing a plurality of output DC currents; (2) the plurality of output DC currents are provided to a plurality of IGBT switching elements, each accepting the output of a corresponding one of the plurality of AC to DC converters (or the plurality of voltage control and rectification circuits) and producing a plurality of output AC currents; (3) the plurality of output AC currents are provided to a plurality of high frequency step up elements each accepting an AC voltage output of a corresponding one of the plurality of IGBT switching elements; and (4) the high frequency high voltage current output from each of the plurality of high frequency step up elements are combined, in series, to produce the combined high frequency high voltage current. Optionally, the plurality of output phases includes three phases and the plurality of IGBT switching elements includes six groups. As another example, the combined high frequency high voltage current can be supplied by a method including the steps of: (1) providing a first DC current in parallel to a first IGBT and a second IGBT; (2) stepping up a first AC voltage output from the first IGBT to produce a first high frequency high voltage current; (3) stepping up a second AC voltage output from the second IGBT to produce a second high frequency high voltage current; and (4) combining, in series, the first and the second high frequency high voltage currents to produce the combined high frequency high voltage current.

Optionally the biomass material can be one or more of paper, paper products, paper waste, wood, particle board, sawdust, agricultural waste, sewage, silage, grasses, straw, wheat straw, rice hulls, bagasse, cotton, jute, hemp, flax, bamboo, sisal, abaca, straw, corn cobs, corn stover, alfalfa, hay, coconut hair, seaweed, algae, and mixtures thereof.

In some cases the methods for processing biomass material include bioprocessing the irradiated material using at least an enzyme or at least a microorganism (e.g., a cellulase, a yeast and/or a bacteria). Optionally, bioprocessing includes saccharifying the irradiated material to provide a sugar and optionally the sugar can be isolated. Optional bioprocessing can produce products including at least one of hydrogen, sugars, sugar alcohols, alcohols, esters of alcohols, biodiesel, organic acids, salts of organic acids, esters of organic acids, hydrocarbons, proteins, enzymes, and mixtures thereof.

An advantage of the invention is that very high efficiencies can be obtained in producing a combined high frequency high voltage current. For example, the invention provides power efficiencies of at least about 60% (e.g., at least about 70%, at least about 80%, at least about 81%, at least about 82%, at least about 83%, at least about 84%, at least about 85%, at least about 86%, at least about 87%, at least about 88%, at least about 89%, at least about 90%, or at least about 95%). A second possible advantage of the invention is that the invention allows for the use of economical, compact, light and/or robust components, for example solid state (e.g., IGBT). A fourth possible advantage of the invention is that the power source described can be integrated close to the equipment it is being used to power, or more remotely using a co-axial cable. A fifth advantage of the invention is that the high frequency voltage provided by the method and system gives a very low ripple current when rectified, a very stable rectified voltage, and improved rectified voltage averaging. For example, when used as a power source for an electron beam, the electron beam power is more uniform and therefore the penetration depth is more uniform than a lower frequency power source. For example, the invention can provide AC voltages with frequencies above at least about 1 KHz (e.g., at least about 5 KHz, at least about 10 KHz, at least about 20 KHz, at least about 40 KHz, at least about 60 KHz, at least about 80 KHz, at least about 90 KHz, at least about 100 KHz, at least about 150 KHz). Other features and advantages of the invention will be apparent from the following detailed description, and from the claims.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, Appendices, patent applications, patents, and other references mentioned herein or attached hereto are incorporated by reference in their entirety for all that they contain. In case of conflict, the present specification, including definitions, will control. In addition, the materials, methods, and examples are illustrative only and not intended to be limiting.

### DESCRIPTION OF DRAWINGS

FIG. 1 is a diagram illustrating the invention.

FIG. 2 is a diagram illustrating a first embodiment of the invention.

FIG. 3 is a circuit diagram of a main power and voltage control.

FIG. 4 is a circuit diagram of a first AC to DC converter, IGBT, and high frequency step up elements.

FIG. 5 is a circuit diagram of a second group of AC to DC converter, IGBT and high frequency step up elements.

FIG. 6 is a circuit diagram of a third group of AC to DC converter, IGBT and high frequency step up elements.

FIG. 7A is a diagrammatic representation of an electron beam accelerator. FIG. 7B is a detailed view of the electron beam accelerator showing an electron gun and controlling electronics.

FIG. 8 is a flow diagram showing a process for irradiation of a biomass.

FIG. 9 is a diagram showing the actions of cellulase enzymes on cellulose.

FIG. 10 is a flow diagram showing processing of biomass to products and co-products.

FIG. 11 is a diagram illustrating a second embodiment of the invention.

FIG. 12 is a circuit diagram of a main power control and three voltage control circuits.

FIG. 13 is a circuit diagram of a first group of filter, IGBT and high frequency step up elements.

FIG. 14 is a circuit diagram of a second group of filter, IGBT and high frequency step up elements.

FIG. 15 is a circuit diagram of a third group of filter, IGBT and high frequency step up elements.

### DETAILED DESCRIPTION

Using the methods and circuits described herein, an input voltage and current can be modulated (e.g., to output a modulated voltage). For example the input voltage can be increased, the input current can be decreased and the frequency can be increased or decreased. In particular, the methods can provide a high frequency, high voltage current with low energy dissipation (e.g., with high efficiency). For example, the methods and systems can produce a frequency of at least about 1 KHz (e.g., at least about 5KHz, at least about 10 KHz, at least about 20 KHz, at least about 40 KHz, at least about 60 KHz, at least about 80 KHz, at least about 90 KHz at least about 100 KHz, at least about 150 KHz) and voltages of more than about 1MV (e.g., more than about 2 MV, more than about SMV, more than about 10 MV, more than about 15MV, more than about 20 MV, more than about 50 MV, more than about 100 MV) and with efficiencies of at least about 60% (e.g., at least about 70%, at least about 80%, at least about 81%, at least about 82%, at least about 83%, at least about 84%, at least about 85%, at least about 86%, at least about 87%, at least about 88%, at least about 89%, at least about 90%,or at least about 95%). The circuits and method can be used, for example, in systems for arc welding, inductive heating, particle accelerators, and Bremstahlung X-Ray devices, for example as a power source for these.

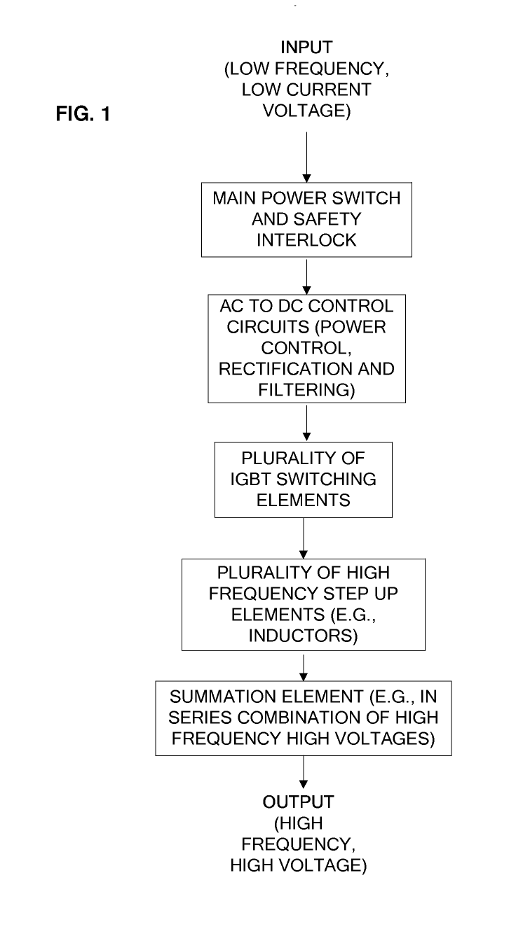

FIG. 1 is a diagram showing an arrangement and operation for the invention. An input to the power source, a low frequency low voltage current, is controlled by a Main Power Switch and Safety Interlock. The voltage is converted to a plurality of DC currents of controlled voltage by AC to DC control circuits (e.g., power control, rectification and filtering). The AC to DC control circuits can include one or more Variacs, one or more AC to DC converter (e.g., a bridge rectifier), one or more filtering elements and one or more voltage control or rectification circuits (e.g., including silicon control rectifiers). The plurality of DC currents drive a plurality of synchronized IGBT switching elements, which then drive a plurality of High Frequency Step Up Elements. A Summation Element (e.g., in series connection of the high frequency currents) outputs a high frequency high voltage current. Two embodiments of the invention will now be described, illustrating some of the details of each element.

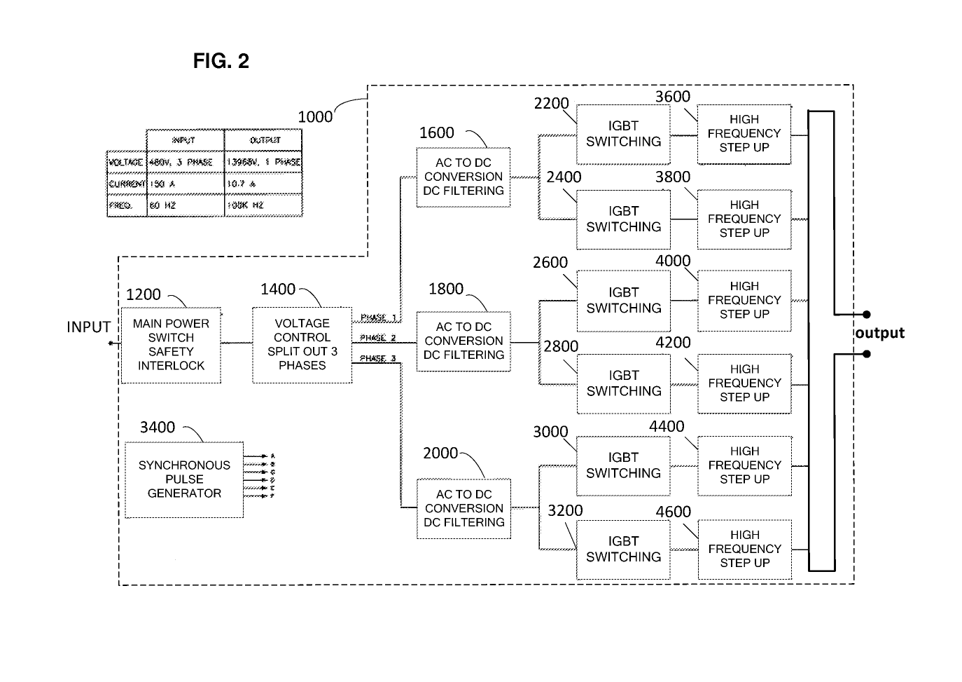

FIG. 2 is a diagram showing an arrangement and operation for one embodiment of the invention. The embodiment is a power source (1000). A three phase, 60 Hz, 150 A, 480 voltage source input is in electrical contact with a Main Power Switch (1200). With the main power switch on, the input voltage is passed to a Voltage Control (1400) which splits the input voltage into the 3 phase components (phase 1, phase 2 and phase 3) and controls the voltage output. Each phase is connected to an AC to DC converter and filter (1600, 1800, 2000). The output DC current from the AC to DC converters and filters are each split into two currents and sent to six IGBT solid state switching devices (2200, 2400, 2600, 2800, 3000, 3200). The IGBT devices are synchronized by a synchronous pulses generator (3400). The 6 IGBT devices drive 6 high frequency step up transformers (3600, 3800, 4000, 4200, 4400, 4600). The output currents from the step up transformers are combined in series. The output is a single phase, 100K Hz, 13968 V, 10.7 A, alternating current.

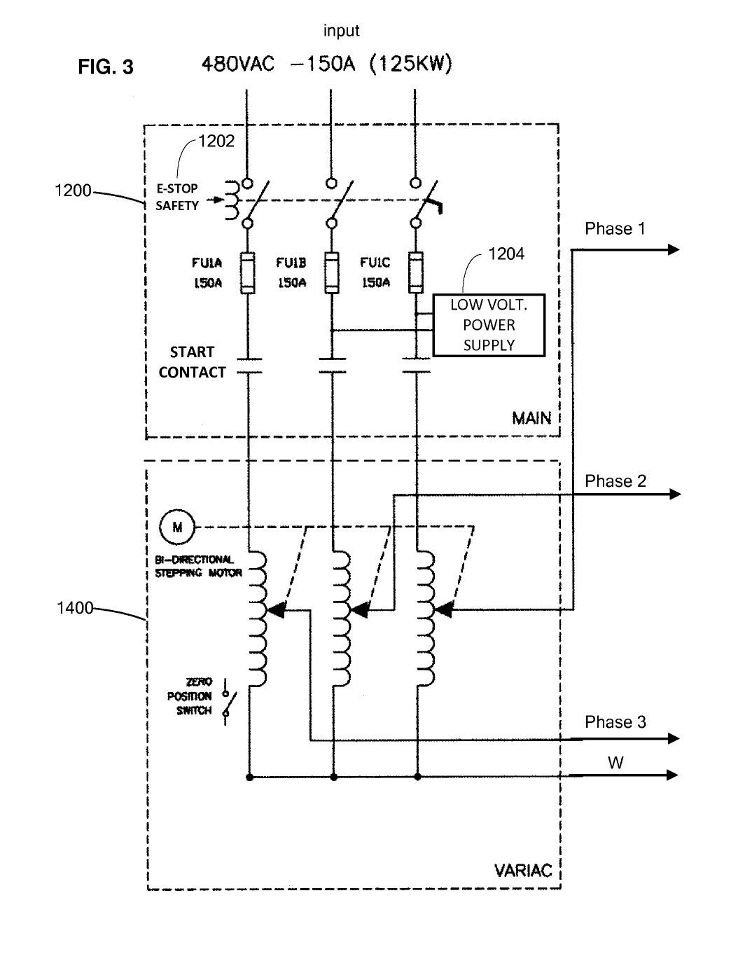

FIG. 3 is a circuit diagram of the Main Power Switch (1200) and Voltage Control (1400). These two circuits safely provide 3 phases of ac voltage where the voltage can be brought up smoothly through three wires. Power is supplied to the Main Power Switch Components as a three phase alternating current that differ by 120 conducting degrees. These are supplied over three wires, although configurations with more wires (e.g., 6 wires) are possible. A shunt trip circuit breaker (1202) allows for remote and/or emergency circuit breaking by a third party circuit and also has a manual handle for breaking the circuit under any unsafe conditions. Fuses FU1A, FU1B, FU1C are used with each input wire after the shunt trip circuit breaker for overcurrent protection and are chosen depending on the power requirements. For example, in the configuration shown, a 150A fuse is used. Alternative to fuses are circuit breakers. Circuit breakers tend to be slower than fuses in breaking the circuit, so generally fuses are preferred. For the circuits as shown in FIG. 3, overcurrent protection up to about 200 A can be optionally used. The low voltage power supply (1204) supplies auxiliary power and is drawn off of two of the main power lines carrying two phases. Auxiliary power drawn off is from about 1 to 5 Amps and supplies power to, for example, PCs, programmable logic controllers, lights, auxiliary circuits, monitors, testers, detectors, alarms and magnetic locks. The auxiliary power can also supply the power to the synchronous pulse generator. The start contact is use to turn power on to the voltage and can be, for example, controlled through a PC interface.

In one embodiment, the three or more wires for carrying the three phases of alternating current are connected in a Wye configuration to three variable autotransformers (e.g., a Variac) located in the Voltage Control circuit (1400). An alternative would be to use a Delta type connection between the three phases, but this does not allow for the independent control of three line voltages. The three autotransformers are synchronously connected to a Bi-directional stepping motor so that the voltage can be controlled simultaneously. For example, for an input 3 phase voltage of 480V, the voltage to each line can be controlled between 0 and 277 Vac. The Main Power Controller and Voltage Control circuit therefor safely provide 3 phases of AC voltage where the voltage can be brought up smoothly through three wires. Some other features of the Main Power Controller and Voltage Control Circuit is providing power with minimum noise generation on adjustment of the voltage and a zero position switch which alerts a PC (not shown) and the operator where the zero voltage occurs. Typically the Voltage Control Circuit can supply powers up to about 200 KW. Larger Variacs, that can control higher currents, are not generally available and energy losses can become significant when low power is needed.

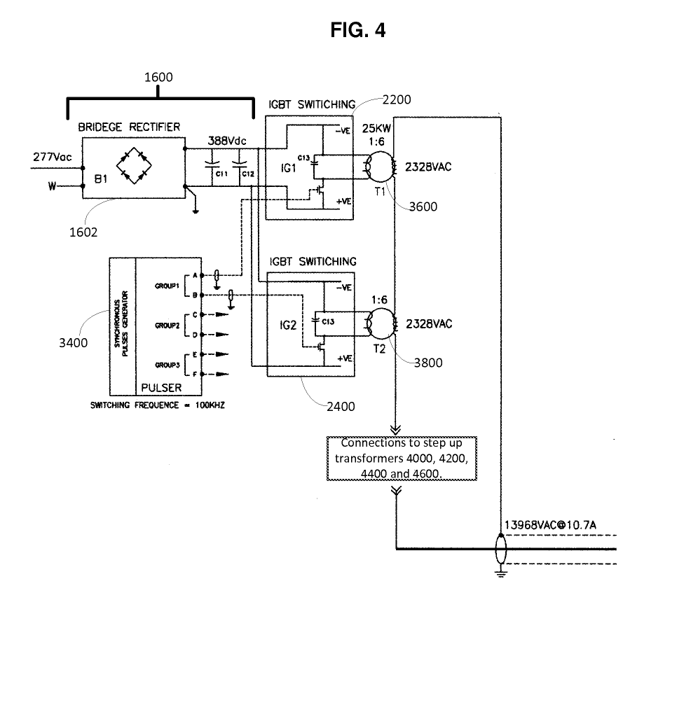

FIG. 4 is a circuit diagram for AC to DC converter and filter (1600), IGBT solid state switching devices (2200 and 2400) and high frequency step up transformers (3600 and 3800). The wire carrying phase 1, for example 277 Vac current, and the wire carrying the neutral line (W) indicted in FIG. 3 are connected to a bridge rectifier (1602). The pulsed DC current output from the bridge rectifier is filtered to provide a pure DC current, for example, the 277 Vac can be converted to a 388 Vdc current. The filtering can be accomplished by a filtering network of capacitors as shown. Two or more capacitors can be used. Alternative configurations are known in the art, for example, using inductors or inductors and capacitors. The filtered DC current is contacted to two IGBTs (2200 and 2400).

Insulated Gate Bipolar Transistors (IGBT) are high frequency solid state current switching devices that are voltage controlled and are made, for example, by Dynex, Fuji, Hitachi, Infineoun, Misubishi, Powerex, Toshiba, Samsung and Intel. Since these are solid state devices heat dissipation can be provide by a suitable heat sink such as a block of aluminum metal with fins and optionally cooled with a cooling fluid (e.g., a cooling gas such as air optionally driven by a fan or a cooling fluid such as an oil or aqueous solution driven by a pump and/or fan). The efficiencies of IGBTs are very high, typically the power efficiencies are greater than 60% (e.g., greater than 70%, greater than 80%, greater than 90% and even greater than 95%). Individually, an IGBT cannot pass a large amount of current, therefore, for the embodiments described the current is split up and multiple IGBT devices are used. For example a voltage of 388V and current of 100A can be used in the IGBTs shown in FIG. 4 and provides a 100 KHz switching. The switching is initiated by the synchronous pulse generator that is in contact with the gates of the IGBT devices, for example group 1 (A and B) are shown connected to two IGBT devices (2200 and 2400).

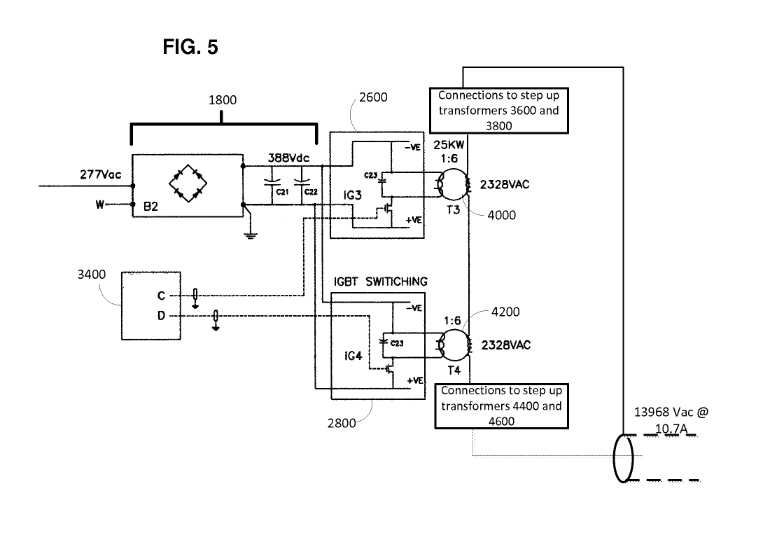

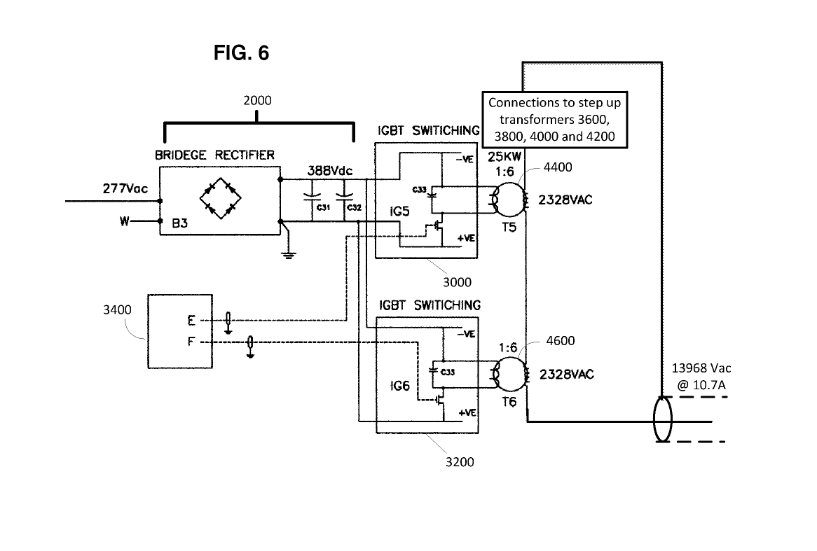

Each IGBT alternating voltage output is in contact with step up transformer for stepping up the voltage 6 times. FIG. 4 shows two of these transformers (3600 and 3800). Therefore for a starting voltage of 388V, each transformer steps up the voltage to about 2328 V. In practice there can be some switching loses and the total voltage is a bit lower, e.g., less than about 2328 V (e.g., 2300 V or lower). The transformers are connected in series to provide a combined high frequency high voltage current. The combined high frequency high voltage current can be delivered to other equipment by a coaxial cable (e.g., RG201 type) FIG. 5 is a circuit diagram for an AC to DC converter and filter (1800), two IGBTs (2600 and 2800) and two high frequency step up transformers (4000 and 4200). FIG. 6 is a circuit diagram for an AC to DC converter and filter (2000), two IGBTs (3000 and 3200) and two high frequency step up transformers (4400 and 4600). The components in FIG. 5 and FIG. 6 are similar to those in FIG. 4 except the synchronous pulse generator connections are to the appropriate corresponding outputs for groups 1, groups 2 and groups 3 respectively and as shown in the figures (A is connected to IGBT (2200), B is connected to IGBT (2400), C is connected to IGBT (2600), D is connected to IGBT (2800), E is connected to IGBT (3000) and F is connected to IGBT (3200)). If each stepped up high frequency voltage is 2328V, the combined voltages of the stepped up high frequency voltages from the transformers (3600, 3800, 4000, 4200, 4400 and 4600) is 13968V.

In an alternative configuration, the currents from the IGBT's could be combined and then a single current stepped up with a single transformer. However, this can present some difficulties since for the larger current a larger diameter wire would be needed, which may be difficult to wind to produce the transformer. Splitting up the current through multiple transformers is therefore preferred.

It would be possible to change the configuration described by FIGS. 2 through 6 to arrive at other embodiments. For example, 2 or more three phase voltage sources could be used with 12 or more IGBTs, configured as in FIGS. 2 through 6, and then the stepped up high frequency output voltages could be combined. Additionally or as an alternative, the DC current output from any one of the AC to DC converters described could be split into 3 (rather than 2) or more currents and connected to 3 or more IGBTs.

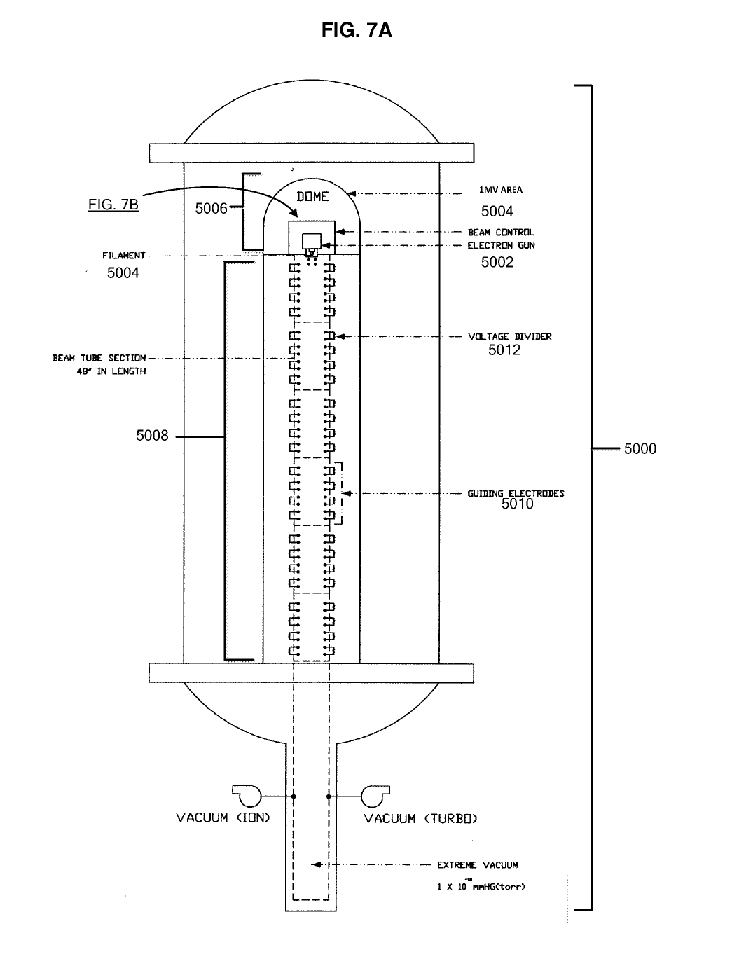

A further modification of the above configurations could allow stepping up the voltage to even greater values. However, the voltage is limited by the maximum safe voltage that can be used by the co-axial cable for the output of the power source. Generally, the voltage is therefore further stepped up in separate components from the power source, after the co-axial cable. For, example, the combined high frequency high voltage source as previously described could be used as a power source for the electron accelerator described by reference to FIG. 7A. Step up transformers in the accelerator can step up the ˜14 KVac voltage to ˜714 KVac and then this is rectified to about negative 1 Million Vdc by rectifying diodes. Filtering capacitors are also used to provide a pure DC current. Electrons are supplied from an electron gun (5002) to an electron accelerator (5000). The electron gun has a filament, e.g., made with tungsten or a tungsten alloy (5004), that can be in a shape to increase surface area (e.g., a spiral) and an electron beam control circuit (5006) all encased in a dome. The dome is a conductive metal and is in contact with the negative 1 Million Vdc from the step up transformers and rectifying diodes. A blow up of the electron gun and beam control circuit are shown in FIG. 7B. The electrons are accelerated in the accelerating tube (5008) by guiding electrodes (5010) made of a plurality of voltage dividers (5012). There can be many, for example 100, voltage dividers, per accelerating tube, each one bringing the voltage down until the end of the acceleration tube where the voltage is at ground.

Even higher voltages can be obtained, such as 2 million (eg., 3 million, 4 million, 5 million, 6 million, 7 million, 8 million, 9 million, or even greater than 10 million). After the accelerating tube, the electrons enter an area where magnetic focusing and raster can occur. The rastering is typically in the x and y plane perpendicular to direction of electron acceleration in the acceleration tube. The electrons exit the gun through a metal foil widow (for example made of titanium, titanium alloy or silicon). In some configurations two or more foil windows are used. Alternatively, in what is known as a differentially pumped orifice, the electrons are ejected through a small opening.

A particle accelerator (e.g., an electron accelerator as described above or an ion beam), can be used for processing biomass (e.g., plant biomass, animal biomass, paper, and municipal waste biomass), for example to reduce the recalcitrance of lignocellulosic material in the biomass. Without being bound to a specific theory, it is believed that such recalcitrance reduction aids and facilitates further processing (e.g., bioproces sing) of lignocellulosic materials to useful products and intermediates such as organic acids, salts of organic acids, anhydrides, esters of organic acids and fuels, e.g., fuels for internal combustion engines or feedstocks for fuel cells.

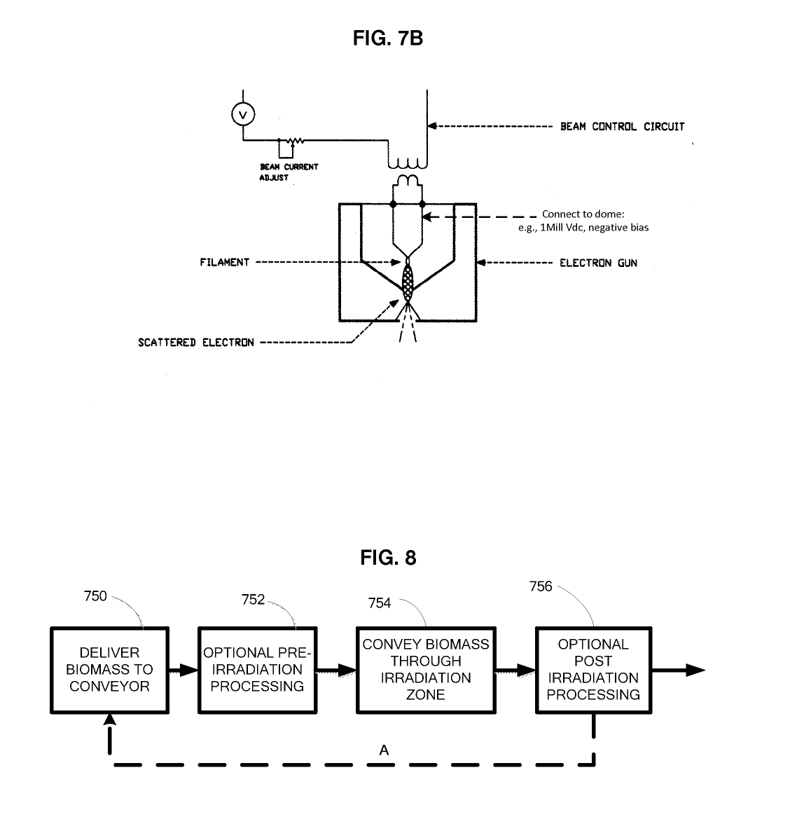

FIG. 8 shows an irradiation process. Initially, biomass can be delivered to a conveyor (750). The biomass can be treated by a pre-irradiation process (752) prior to it being conveyed through an irradiation zone (754). After irradiation, the biomass can be post processed (756). The process can be repeated (e.g., dashed arrow A).

In order to convert the feedstock to a form that can be readily processed the glucan- or xylan-containing polysaccharides in lignocellulose or cellulose in the feedstock can be hydrolyzed to low molecular weight carbohydrates, such as sugars, by a saccharifying agent, e.g., an enzyme or acid, a process referred to as saccharification. The low molecular weight carbohydrates can then be used, for example, in an existing manufacturing plant, such as a single cell protein plant, an enzyme manufacturing plant, or a fuel plant, e.g., an ethanol manufacturing facility.

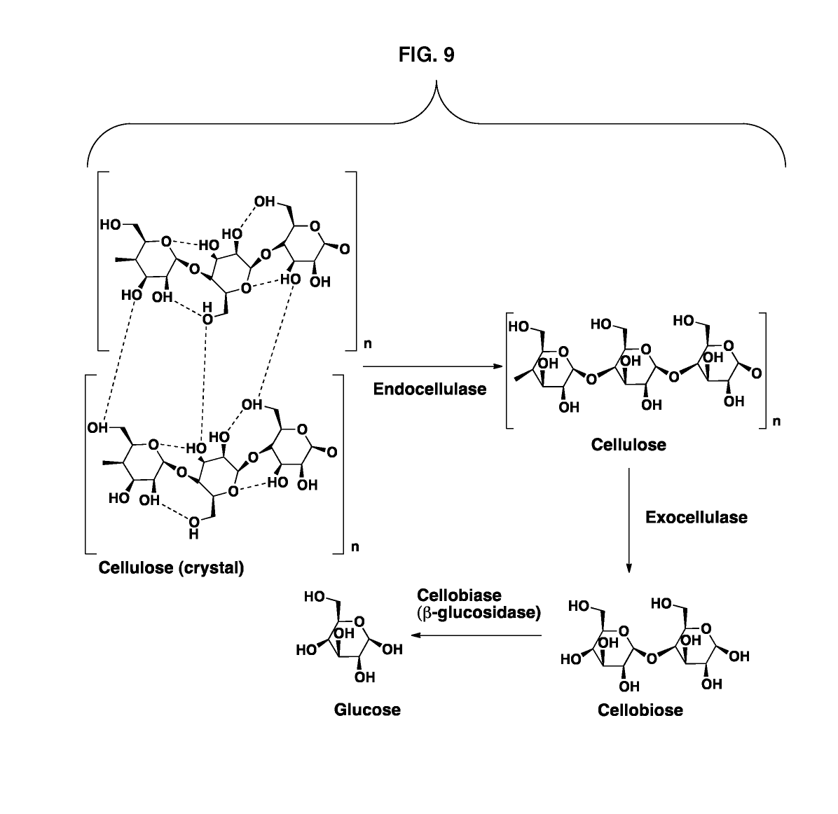

The feedstock can be hydrolyzed using an enzyme, e.g., by combining the materials and the enzyme in a solvent, e.g., in an aqueous solution. Enzymes and biomass-destroying organisms that break down biomass, such as the cellulose and/or the lignin portions of the biomass, contain or manufacture various cellulolytic enzymes (cellulases), ligninases or various small molecule biomass-destroying metabolites. These enzymes may be a complex of enzymes that act synergistically to degrade crystalline cellulose or the lignin portions of biomass. Examples of cellulolytic enzymes include: endoglucanases, cellobiohydrolases, and cellobiases (β-glucosidases).Referring to FIG. 9, during saccharification a cellulosic substrate is initially hydrolyzed by endoglucanases at random locations producing oligomeric intermediates. These intermediates are then substrates for exo-splitting glucanases such as cellobiohydrolase to produce cellobiose from the ends of the cellulose polymer. Cellobiose is a water-soluble 1,4-linked dimer of glucose. Finally, cellobiase cleaves cellobiose to yield glucose. The efficiency (e.g., time to hydrolyze and/or completeness of hydrolysis) of this process depends on the recalcitrance of the cellulosic material. The recalcitrance can be reduced relative to the native feedstock by irradiation, for example, with an ion beam.

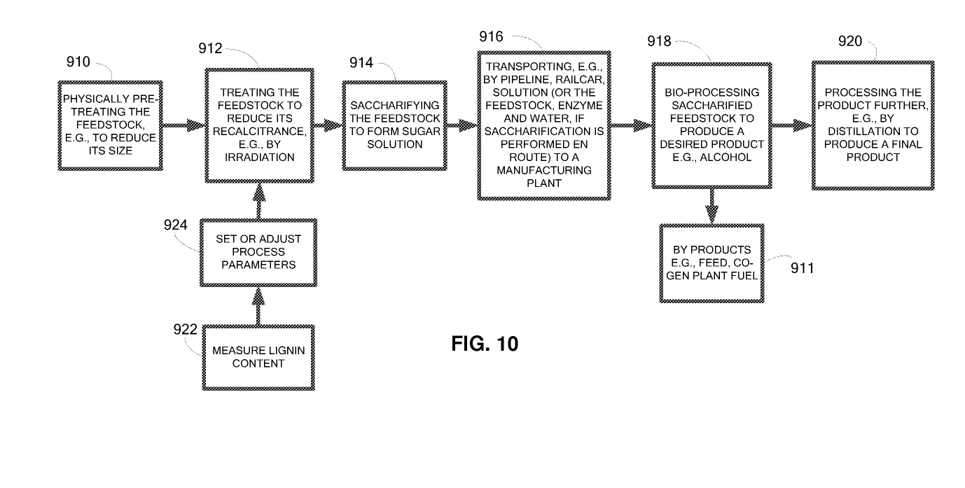

Saccharified biomass can be manufactured into various products by the methods described herein, for example, by reference to FIG. 10, showing a process for manufacturing a sugar and other products (e.g., an alcohol) can include, for example, optionally mechanically treating a feedstock (step 910), before and/or after this treatment, treating the feedstock with another physical treatment, for example irradiation by the methods described herein, to further reduce its recalcitrance (step 912), and saccharifying the feedstock, to form a sugar solution (step 914). Optionally, the method may also include transporting, e.g., by pipeline, railcar, truck or barge, the solution (or the feedstock, enzyme and water, if saccharification is performed en route) to a manufacturing plant (step 916). In some cases the saccharified feedstock is further bioprocessed (e.g., fermented) to produce a desired product (step 918) and byproduct (911). The resulting product may in some implementations be processed further, e.g., by distillation (step 920). If desired, the steps of measuring lignin content (step 922) and setting or adjusting process parameter (e.g., irradiation time or power) based on this measurement (step 924) can be performed at various stages of the process, as described in U.S. patent application Ser. No. 12/704,519, filed on Feb. 11, 2010, the complete disclosure of which is incorporated herein by reference.

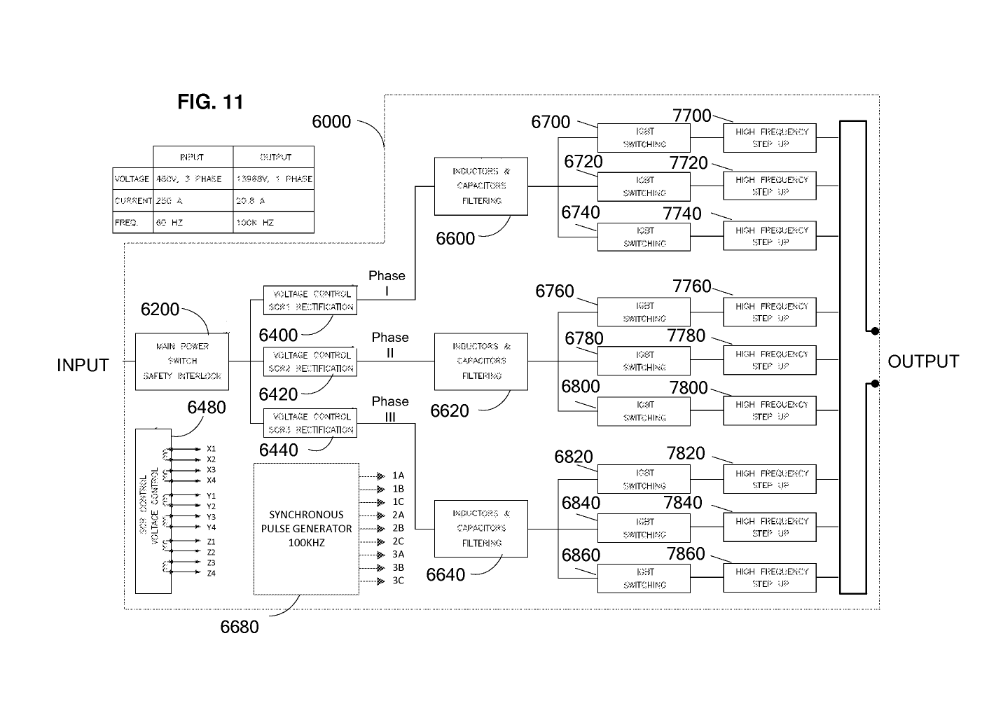

FIG. 11 is a diagram showing an arrangement and operation for another embodiment of the invention, contrasting, for example, with the arrangement of FIG. 2.

The embodiment is the power source (6000). A three phase, 60 Hz, 250A, 480 voltage source input is in electrical contact with a Main Power Switch (6200). With the main power switch on, three phases are divided up among three voltage control and rectification circuits, e.g., SCR1, SCR2 and SCR3, (6400, 6420 and 6440). The conducting angle (voltage control) is controlled by an SCR (Silicon Control Rectifiers) secondary control circuit (6480). After voltage control and rectification each phase is filtered to provide three pure DC currents. Each DC current is split three ways and sent to nine IGBTs (6700, 6720, 6740, 6760, 6780, 6800, 6820, 6840 and 6860). The IGBTs are synchronized by a synchronous pulses generator (6680). The nine IGBT devices drive nine high frequency step up transformers (7700, 7720, 7740, 7760, 7780, 7800, 7820, 7840 and 7860). The output currents from the step up transformers are combined in series. The output is a single phase, 100 KHz alternating current, 13968 V and 20.8 A.

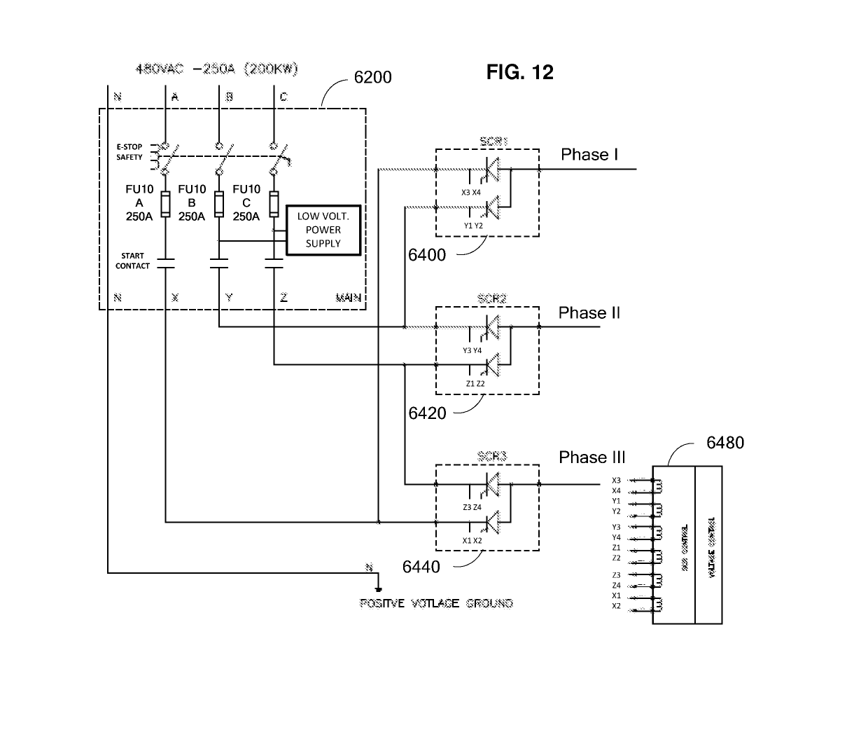

FIG. 12 is a circuit diagram of the Main Power Switch (6200) and the three voltage control and rectification circuits, e.g., SCR1, SCR2 and SCR3, (6400, 6420 and 6440). The components of the Main Power Switch are similar to those in FIG. 2 (1200) excepting the rating for the components are for the higher power, for example the fuses (FU10A, FU10B and FU10C) are rated for passing 250 A each in this configuration. Fuses rated for higher currents can be used as needed. The three voltage control and rectification circuits each include two SCRs (Silicon Control Rectifiers) connected as shown to the three phase voltage source. The conducting angle is controlled by an SCR (Silicon Control Rectifier) secondary control circuit (6480) so that a rectified current with controlled power is supplied as the three synchronous output phases, Phase I, Phase II and Phase III. Some features of the Main Power Controller and Three Voltage Control and Rectification circuits is providing power safely from zero to the maximum from the three phase source with powers even above about 200 KW (e.g., at least about 400 KW, at least about 600 KW, at least about 800 KW, at least about 1000 KW) with very little power losses even at low power.

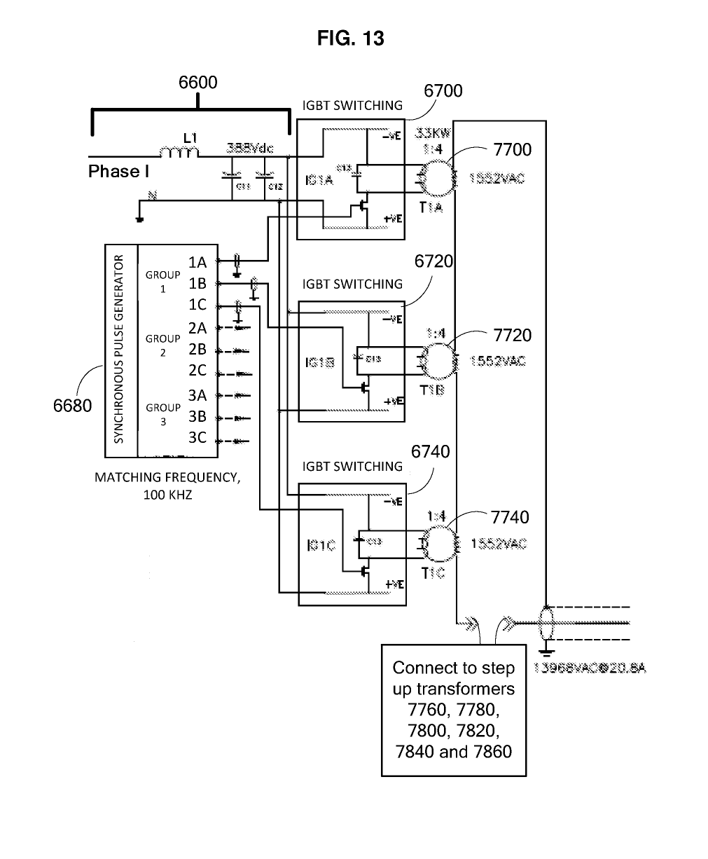

FIG. 13 is a circuit diagram for a filter (6600), IGBT solid state switch devices (6700, 6720 and 6740), and higher frequency step up devices (7700, 7720 and 7740). The filter can include capacitors and inductors, balanced to provide a pure DC current (e.g., 388 Vdc). After filtering the current is passed in parallel to three IGBT devices as shown. The number of IGBT devices used depends on the current and power and specifications of the IGBT. The IGBT devices are matched. Switching is accomplished by the synchronous pulse generator that is in contact with the gates of the IGBT devices, for example, group 1 (1A, 1B and 1C) are connected to the gates of 6700, 6720 and 6740 respectively.

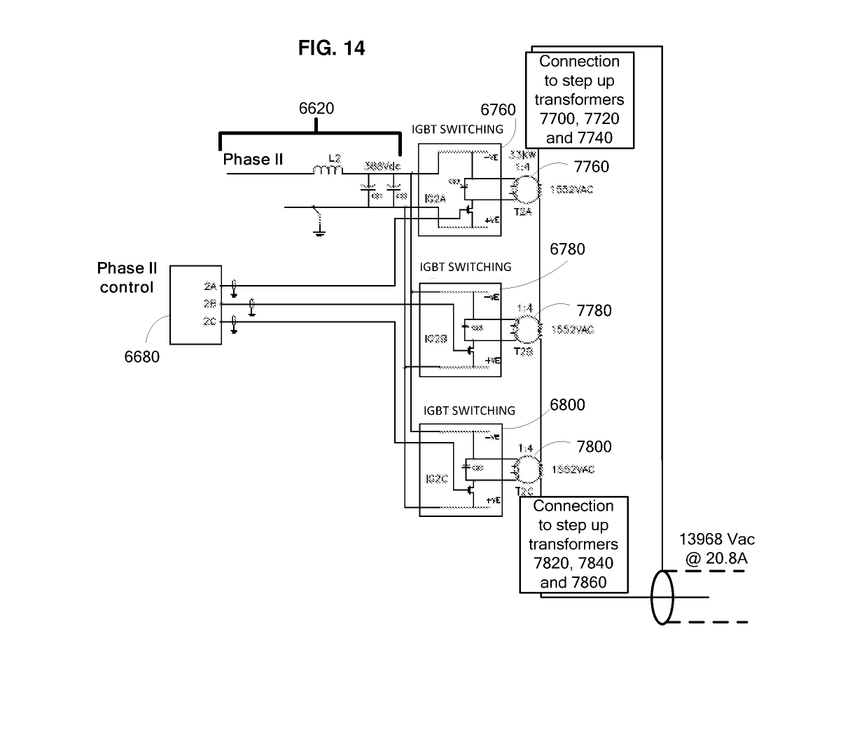

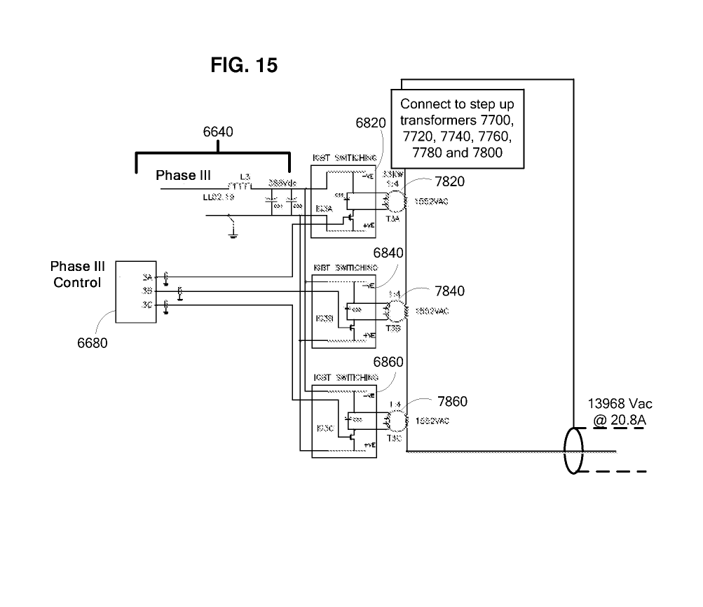

Each IGBT alternating voltage output is in contact with a step up transformer for stepping up the voltage 4 times. FIG. 13 shows three of these step up transformers (7770, 7720 and 7740). As previously described, in practice there can be some switching losses to the total ideal voltage for each transformer output, e.g., the voltage can be less than 1552 V for each transformer output (e.g., less than about 1550 V, less than about 1400 V). The transformers are connected in series to provide a combined high frequency high voltage current. The combined higher frequency high voltage current can be delivered to other equipment by a coaxial cable (e.g., RG201 Type). FIG. 14 is a circuit diagram for a filter (6620), three IGBTs (6760, 6780 and 6800) and three high frequency step up transformers (7760, 7780 and 7800). FIG. 15 is a circuit diagram for a filter (6640), three

IGBTs (6820, 6840 and 6860) and three high frequency step up transformers (7820, 7840 and 7860). The components in FIGS. 14 and 15 are as previously described with respect to FIG. 13 except that the synchronous pulse generator connections are to the appropriate corresponding outputs from groups 1, groups 2 and 3 respectively and as shown in the FIG.s (1A is connected to IGBT (6700), 1B is connected to IGBT (6720), 1C is connected to IGBT (6780), 2A is connected to IGBT (6760), 2B is connected to IGBT (6780), 2C is connected to IGBT (6800), 3A is connected to IGBT (6820), 3B is connected to IGBT (6840), and 3C is connected to IGBT (6860)).

Generally, embodiments that use SCR components as illustrated by FIG. 11, are useful for providing a higher current (e.g., higher power) than those using Variacs (e.g., as illustrated by FIG. 2). Therefore, for uses where a high power is required (e.g., greater than about 200 KW), embodiments using SCR components can be used. A drawback of using embodiements with SCR components is the circuits must be carefully balanced and filtered (e.g., filtering with inductors and/or capacitors). Embodiments using Varicacs can be simpler with respect to filtering since they provide a less noisy output current that requires less complex filtering an balancing. Variacs tend to dissipate more energy, especially at low voltages (e.g., with startup), than SCR circuits. Many of the components of the two embodiments are similar or require slight modifications to function efficiently.

### Irradiation

The power sources as described (e.g., providing a combined high frequency high voltage current) can be used to power different kinds of particle accelerators. For example, electron accelerators that can use the power source include electrocurtain systems, grounded transformer accelerators, insulated core transformer accelerators (e.g., Van de Graaff accelerators), air-core transformer accelerators (e.g., ELV-accelerators and TORCH accelerators), cascade accelerators (e.g., Cockroft-Walton Accelerators), low energy accelerators with a scanning system, low energy accelorators with a linear cathode, linear accelorators or Dynamitrons. Electron beam irradiation devices may be procured commercially from Ion Beam Applications, Louvain-la-Neuve, Belgium or the Titan Corporation, San Diego, Calif. The power source can also be used for heavier particle accelerators such as electrostatic DC, electrodynamic DC, RF linear, magnetic induction linear, continuous wave, linear accelerators or cyclotrons. For example, cyclotron type accelerators are available from IBA, Belgium, such as the Rhodotron® system, while DC type accelerators are available from RDI, now IBA Industrial, such as the Dynamitron.

Each form of radiation ionizes the biomass via particular interactions, as determined by the energy of the radiation. Electrons interact with materials via Coulomb scattering and bremsstrahlung radiation produced by changes in the velocity of electrons. Heavy charged particles primarily ionize matter via Coulomb scattering; furthermore, these interactions produce energetic electrons that may further ionize matter.

When particles are utilized, they can be neutral (uncharged), positively charged or negatively charged. When charged, the charged particles can bear a single positive or negative charge, or multiple charges, e.g., one, two, three or even four or more charges. In instances in which chain scission is desired to change the molecular structure of the carbohydrate containing material, positively charged particles may be desirable, in part, due to their acidic nature. When particles are utilized, the particles can have the mass of a resting electron, or greater, e.g., 500, 1000, 1500, or 2000 or more times the mass of a resting electron. For example, the particles can have a mass of from about 1 atomic unit to about 150 atomic units, e.g., from about 1 atomic unit to about 50 atomic units, or from about 1 to about 25, e.g., 1, 2, 3, 4, 5, 10, 12 or 15 amu.

As previously described, an electron gun can be used as an electron source via thermionic emission and these electrons can then be accelerated. A beam of electrons has the advantages of high dose rates (e.g., 1, 5, or even 10 Mrad per second), high throughput, less containment, and less confinement equipment. Use of the power source as discussed herein, electron beams can also have high electrical efficiency (e.g. greater than 60%, greater than 70%, greater than 80% or greater than 90%) allowing for a low energy usage, which can translate into a low cost of operation and low greenhouse gas emissions corresponding to the small amount of energy used. Electrons can also be efficient at causing changes in the molecular structure of carbohydrate-containing materials, for example, by the mechanism of chain scission. In addition, electrons having energies of 4-10 MeV can have a penetration depth of 5 to 30 mm or more, such as 40 mm. In low bulk density materials, such as many of the materials described herein, e.g., materials having a bulk density of less than about 0.5 g/cm³, electrons having energies in the 4-10 MeV range can penetrate 4-8 inches or even more. In some preferred embodiments, using the power sources described herein, electrons having average energies between 0.5 and 6 MeV and penetration depths between about 1 mm and 7 mm are used. Electron beams can be generated, e.g., by electrostatic generators, cascade generators, transformer generators, low energy accelerators with a scanning system, low energy accelerators with a linear cathode, linear accelerators, and pulsed accelerators. Electrons as an ionizing radiation source can be useful, e.g., for relatively thin piles of materials, e.g., less than about 0.5 inch, e.g., less than about 0.4 inch, less than about 0.3 inch, less than about 0.25 inch, or less than about 0.1 inch. In some embodiments, the energy of each electron of the electron beam is from about 0.3 MeV to about 2.0 MeV (million electron volts), e.g., from about 0.5 MeV to about 1.5 MeV, or from about 0.7 MeV to about 1.25 MeV.

Typical electron energies can be 0.5 MeV, 1 MeV, 2 MeV, 4.5 MeV, 7.5 MeV, or 10 MeV. Typical electron beam irradiation device power can be 1 kW, 5 KW, 10 KW, 20 KW, 50 KW, 100 KW, 250 KW, or 500 KW or even 1000 KW. Effectiveness of changing the molecular/supermolecular structure and/or reducing the recalcitrance of the carbohydrate-containing biomass depends on the electron energy used and the dose applied, while exposure time depends on the power and dose. Typical doses may take values of about 0.1 Mrad, about 0.5 Mrad, about 1 Mrad, about 2 Mrad, about 5 Mrad, about 10 Mrad, about 20 Mrad, about 40 Mrad, about 50 Mrad, about 60 Mrad, about 70 Mrad, about 80 Mrad, about 90 Mrad, about 100 Mrad, about 110 Mrad, about 120 Mrad, about 130 Mrad, about 140 Mrad, about 150 Mrad or even about 200 Mrad). Typical dose can be in the range of about 0.1 to 200 Mrad (e.g., about 1 to 200 Mrad, about 5 to 200 Mrad, about 5 to 150 Mrad, about 5 to 100 Mrad, about 5 to 50 Mrad, about 5 to 40 Mrad, about 10 to 150 Mrad, about 40 to 150 Mrad, about 50 to 150 Mrad, about 80 to 120 Mrad).

Tradeoffs in considering electron beam irradiation device power specifications include cost to operate, capital costs, depreciation, and device footprint. Tradeoffs in considering exposure dose levels of electron beam irradiation would be energy costs and environment, safety, and health (ESH) concerns. Typically, generators are housed in a vault, e.g., of lead or concrete. Tradeoffs in considering electron energies include energy costs.

The electron beam irradiation device can produce either a fixed beam or a scanning beam. A scanning beam may be advantageous with large scan sweep length and high scan speeds, as this would effectively replace a large, fixed beam width. Further, available sweep widths of 0.5 m, 1 m, 2 m, 3m or more are available. Rastering of the beam in the perpendicular direction is typically smaller, e.g., less than about 100 cm (e.g., less than about 50 cm, less than about 25 cm, less than about 10 cm).

Particles heavier than electrons can be utilized to irradiate carbohydrates or materials that include carbohydrates, e.g., cellulosic materials, lignocellulosic materials, starchy materials, or mixtures of any of these and others described herein. For example, protons, helium nuclei, argon ions, silicon ions, neon ions carbon ions, phoshorus ions, oxygen ions or nitrogen ions can be utilized. In some embodiments, particles heavier than electrons can induce higher amounts of chain scission. In some instances, positively charged particles can induce higher amounts of chain scission than negatively charged particles due to their acidity.

In some embodiments, the energy of each particle of the beam is from about 1.0 MeV/atomic unit to about 6,000 MeV/atomic unit, e.g., from about 3 MeV/ atomic unit to about 4,800 MeV/atomic unit, or from about 10 MeV/atomic unit to about 1,000 MeV/atomic unit.

In some embodiments, the irradiating (with any radiation source or a combination of sources) is performed until the material receives a dose of at least about 0.05 Mrad, e.g., at least about 0.1, 0.25, 1.0, 2.5, 5.0, or 10.0 Mrad. In some embodiments, the irradiating is performed until the material receives a dose of between about 1.0 Mrad and 6.0 Mrad, e.g., between about 0.5 and 5 Mrad, between about 1.0 Mrad and 4.0 Mrad or between about 1.5 Mrad and 4 Mrad. In other embodiments, irradiating is performed at a dose between about 0.1 MRad and about 10 MRad, e.g., between about 0.25 MRad and about 9 MRad, between about 0.5 MRad and about 7.5 MRad or between about 0.75 MRad and about 5 MRad.

In some embodiments, the irradiating is performed at a dose rate of between 5.0 and 1500.0 kilorads/hour, e.g., between 10.0 and 750.0 kilorads/hour or between 50.0 and 350.0 kilorads/hours.

In some embodiments, two or more radiation sources are used, such as two or more ionizing radiations. For example, samples can be treated, in any order, with a beam of electrons, followed by gamma radiation and UV light having wavelengths from about 100 nm to about 280 nm. In some embodiments, samples are treated with three ionizing radiation sources, such as a beam of electrons, gamma radiation, and energetic UV light.

In some cases the radiation is X-ray (bremsstrahlung) photons. X-ray photons are emitted with energetic electrons, for example created by an electron beam powered by a power source as described herein, are intercepted by any material. The X-Rays can be produced by an X-ray tube or by an electron beam interacting with a material (e.g., biomass or material added to a biomass. Materials added to a biomass are described in U.S. application Ser. No. 12/605,534 the entire disclosure incorporated herein by reference. The depth-dose distributions for large area X-ray beams are nearly exponential from the surface of the irradiated material.

To obtain maximum X-ray power utilization when materials with low atomic numbers are treated from opposite sides, the optimum thickness should be about 34 g/cm² at 5 MeV, 38 g/cm² at 7.5 MeV and 43 g/cm² at 10 MeV. The practical value of X-ray power utilization efficiency is defined by the minimum dose in the middle of the material multiplied by the total mass throughput rate and divided by the emitted X-ray power. Increasing the thickness beyond the optimum value reduces the minimum dose more than the mass throughput rate increases, thereby decreasing the practical power utilization efficiency. For irradiation on one side of the material the optimum thickness is less than for irradiating on one side of the material e.g., approximately half that of irradiating on both sides.

### Mechanical Treatments

In some cases, a biomass can be mechanically treated, eg., for size reduction of the material, such as by cutting, grinding shearing, pulverizing. For example, in some cases, loose feedstock (e.g., recycled paper, starchy materials, or switchgrass) is comminuted by shearing or shredding.

Alternatively, or in addition, the feedstock material can first be physically treated by one or more of the other physical treatment methods, e.g., chemical treatment, radiation, sonication, oxidation, pyrolysis or steam explosion, and then mechanically treated. This sequence can be advantageous since materials treated by one or more of the other treatments, e.g., irradiation or pyrolysis, tend to be more brittle and, therefore, it may be easier to further change the molecular structure of the material by mechanical treatment. For example, a feedstock material can be conveyed through ionizing radiation as described herein and then mechanically treated.

In addition to this size reduction, which can be performed initially and/or later during processing, mechanical treatment can also be advantageous for “opening up,” “stressing,” breaking or shattering the carbohydrate-containing materials, making the cellulose of the materials more susceptible to chain scission and/or disruption of crystalline structure during the physical treatment.

Methods of mechanically treating the carbohydrate-containing material include, for example, milling or grinding. Milling may be performed using, for example, a hammer mill, ball mill, colloid mill, conical or cone mill, disk mill, edge mill, Wiley mill or grist mill. Grinding may be performed using, for example, a cutting/impact type grinder. Specific examples of grinders include stone grinders, pin grinders, coffee grinders, and burr grinders. Grinding or milling may be provided, for example, by a reciprocating pin or other element, as is the case in a pin mill. Other mechanical treatment methods include mechanical ripping or tearing, other methods that apply pressure to the fibers, and air attrition milling. Suitable mechanical treatments further include any other technique that continues the disruption of the internal structure of the material that was initiated by the previous processing steps.

Mechanical feed preparation systems can be configured to produce streams with specific characteristics such as, for example, specific maximum sizes, specific length-to-width, or specific surface areas ratios. Physical preparation can increase the rate of reactions, improve the irradiation profile of the material, improve the radiation uniformity of the material, or reduce the processing time required by opening up the materials and making them more accessible to processes and/or reagents, such as reagents in a solution. The bulk density of feedstocks can be controlled (e.g., increased). In some situations, it can be desirable to prepare a low bulk density material, e.g., by densifying the material (e.g., densification can make it easier and less costly to transport to another site) and then reverting the material to a lower bulk density state. The material can be densified, for example from less than about 0.2 g/cc to more than about 0.9 g/cc (e.g., less than about 0.3 to more than about 0.5 g/cc, less than about 0.3 to more than about 0.9 g/cc, less than about 0.5 to more than about 0.9 g/cc, less than about 0.3 to more than about 0.8 g/cc, less than about 0.2 to more than about 0.5 g/cc). For example, the material can be densified by the methods and equipment disclosed in U.S. Pat. No. 7,932,065 and WO 2008/073186, the full disclosures of which are incorporated herein by reference. Densified materials can be processed by any of the methods described herein, or any material processed by any of the methods described herein can be subsequently densified.

In some embodiments, the material to be processed is in the form of a fibrous material that includes fibers provided by shearing a fiber source. For example, the shearing can be performed with a rotary knife cutter.

Mechanical treatments that may be used, and the characteristics of the mechanically treated carbohydrate-containing materials, are described in further detail in U.S. Ser. No. 13/276,192, filed Oct. 18, 2011, the full disclosure of which is hereby incorporated herein by reference.

### Sonication, Pyrolysis, Oxidation, Steam Explosion

If desired, one or more sonication, pyrolysis, oxidative, or steam explosion processes can be used in addition to irradiation to reduce the recalcitrance of the carbohydrate-containing material. For example, inductive heating using the power source described herein can be used to pyrolyze carbohydrate containing biomass. Some processes are described in detail in U.S. Ser. No. 12/429,045, the full disclosure of which is incorporated herein by reference.

### Saccharification

The biomass material processed by methods described herein, e.g., irradiation, may be subsequently saccharified, generally by combining the material and a cellulase enzyme in a fluid medium, e.g., an aqueous solution. In some cases, the material is boiled, steeped, or cooked in hot water prior to saccharification, as described in U.S. Ser. No. 13/276,192, filed Oct. 18, 2011.

The saccharification process can be partially or completely performed in a tank (e.g., a tank having a volume of at least about 4000, 40,000, or 500,000 L) in a manufacturing plant, and/or can be partially or completely performed in transit, e.g., in a rail car, tanker truck, or in a supertanker or the hold of a ship. The time required for complete saccharification will depend on the process conditions and the carbohydrate-containing material and enzyme used. If saccharification is performed in a manufacturing plant under controlled conditions, the cellulose may be substantially entirely converted to glucose in about 12-96 hours. If saccharification is performed partially or completely in transit, saccharification may take longer.

It is generally preferred that the tank contents be mixed during saccharification, e.g., using jet mixing as described in U.S. Provisional Application No. 61/218,832, the full disclosure of which is incorporated by reference herein.

The addition of surfactants can enhance the rate of saccharification. Examples of surfactants include non-ionic surfactants, such as a Tween® 20 or Tween® 80 polyethylene glycol surfactants, ionic surfactants, or amphoteric surfactants.

It is generally preferred that the concentration of the sugar solution resulting from saccharification be relatively high, e.g., greater than 40%, or greater than 50, 60, 70, 80, 90 or even greater than 95% by weight. This reduces the volume to be shipped, and also inhibits microbial growth in the solution. However, lower concentrations may be used, in which case it may be desirable to add an antimicrobial additive, e.g., a broad spectrum antibiotic, in a low concentration, e.g., 50 to 150 ppm. Other suitable antibiotics include amphotericin B, ampicillin, chloramphenicol, ciprofloxacin, gentamicin, hygromycin B, kanamycin, neomycin, penicillin, puromycin, streptomycin. Antibiotics will inhibit growth of microorganisms during transport and storage, and can be used at appropriate concentrations, e.g., between 15 and 1000 ppm by weight, e.g., between 25 and 500 ppm, or between 50 and 150 ppm. If desired, an antibiotic can be included even if the sugar concentration is relatively high.

A relatively high concentration solution can be obtained by limiting the amount of water added to the carbohydrate-containing material with the enzyme. The concentration can be controlled, e.g., by controlling how much saccharification takes place. For example, concentration can be increased by adding more carbohydrate-containing material to the solution. In order to keep the sugar that is being produced in solution, a surfactant can be added, e.g., one of those discussed above. Solubility can also be increased by increasing the temperature of the solution, for example at least maintaining the temperature at 40° C. For example, the solution can be maintained at a temperature of about 40-100° C. (e.g., 40-50° C., 50-60° C., 60-80° C., or even higher).

### Sugars

In the processes described herein, for example after saccharification, sugars (e.g., glucose and xylose) can be isolated. For example sugars can be isolated by precipitation, crystallization, chromatography (e.g., similated moving bed chromatography, high pressure chromatography), centrifugation, extraction and combinations thereof.

### Hydrogenation

The processes described herein can include hydrogenation. For example glucose and xylose can be hydrogenated to sorbitol and xylitol respectively. Hydrogenation can be accomplished by use of a catalyst e.g., Pt/γ-Al₂O₃, Ru/C, Raney Nickel in combination with H₂ under high pressure e.g., 10 to 12000 psi.

### Fermentation

Yeast and Zymomonas bacteria, for example, can be used for fermentation or conversion. Other microorganisms are discussed in the Materials section, below. The optimum pH for fermentations is about pH 4 to 7. For example, the optimum pH for yeast is from about pH 4 to 5, while the optimum pH for Zymomonas is from about pH 5 to 6. Typical fermentation times are about 24 to 168 hours (e.g., 24 to 96 hrs) with temperatures in the range of 20° C. to 40° C. (e.g., 26° C. to 40° C.), however thermophilic microorganisms prefer higher temperatures.

In some embodiments e.g., when anaerobic organisms are used, at least a portion of the fermentation is conducted in the absence of oxygen e.g., under a blanket of an inert gas such as N₂, Ar, He, CO₂ or mixtures thereof. Additionally, the mixture may have a constant purge of an inert gas flowing through the tank during part of or all of the fermentation. In some cases, anaerobic condition can be achieved or maintained by carbon dioxide production during the fermentation and no additional inert gas is needed. In some embodiments, all or a portion of the fermentation process can be interrupted before the low molecular weight sugar is completely converted to a product (e.g, ethanol). The intermediate fermentation products include high concentrations of sugar and carbohydrates. The sugars and carbohydrates can be isolated as discussed below. These intermediate fermentation products can be used in preparation of food for human or animal consumption. Additionally or alternatively, the intermediate fermentation products can be ground to a fine particle size in a stainless-steel laboratory mill to produce a flour-like substance.

Jet mixing may be used during fermentation, and in some cases saccharification and fermentation are performed in the same tank.
Nutrients may be added during saccharification and/or fermentation, for example the food-based nutrient packages described in U.S. Ser. No. 61/365,493, the complete disclosure of which is incorporated herein by reference.

The fermentations include the methods and products that are disclosed in U.S. Provisional Application Ser. No. 61/579,559, filed Dec. 22, 2012, and U.S. application 61/579,576, filed Dec. 22, 2012 incorporated by reference herein in its entirety.

Mobile fermentors can be utilized, as described in U.S. Ser. No. 12/374,549 and International Application No. WO 2008/011598. Similarly, the saccharification equipment can be mobile. Further, saccharification and/or fermentation may be performed in part or entirely during transit.

### Distillation

After fermentation, the resulting fluids can be distilled using, for example, a “beer column” to separate ethanol and other alcohols from the majority of water and residual solids. The vapor exiting the beer column can be, e.g., 35% by weight ethanol and can be fed to a rectification column. A mixture of nearly azeotropic (92.5%) ethanol and water from the rectification column can be purified to pure (99.5%) ethanol using vapor-phase molecular sieves. The beer column bottoms can be sent to the first effect of a three-effect evaporator. The rectification column reflux condenser can provide heat for this first effect. After the first effect, solids can be separated using a centrifuge and dried in a rotary dryer. A portion (25%) of the centrifuge effluent can be recycled to fermentation and the rest sent to the second and third evaporator effects. Most of the evaporator condensate can be returned to the process as fairly clean condensate with a small portion split off to waste water treatment to prevent build-up of low-boiling compounds.

### Intermediates and Products

Using the processes described herein, the treated biomass can be converted to one or more products, such as energy, fuels, foods and materials. Specific examples of products include, but are not limited to, hydrogen, sugars (e.g., glucose, xylose, arabinose, mannose, galactose, fructose, disaccharides, oligosaccharides and polysaccharides), alcohols (e.g., monohydric alcohols or dihydric alcohols, such as ethanol, n-propanol, isobutanol, sec-butanol, tert-butanol or n-butanol), hydrated or hydrous alcohols, e.g., containing greater than 10%, 20%, 30% or even greater than 40% water, xylitol, biodiesel, organic acids, hydrocarbons (e.g., methane, ethane, propane, isobutene, pentane, n-hexane, biodiesel, bio-gasoline and mixtures thereof), co-products (e.g., proteins, such as cellulolytic proteins (enzymes) or single cell proteins), and mixtures of any of these in any combination or relative concentration, and optionally in combination with any additives, e.g., fuel additives. Other examples include carboxylic acids, salts of a carboxylic acid, a mixture of carboxylic acids and salts of carboxylic acids and esters of carboxylic acids (e.g., methyl, ethyl and n-propyl esters), ketones (e.g., acetone), aldehydes (e.g., acetaldehyde), alpha, beta unsaturated acids, such as acrylic acid and olefins, such as ethylene. Other alcohols and alcohol derivatives include propanol, propylene glycol, 1,4-butanediol, 1,3-propanediol, sugar alcohols (e.g., erythritol, glycol, glycerol, sorbitol threitol, arabitol, ribitol, mannitol, dulcitol, fucitol, iditol, isomalt, maltitol, lactitol, xylitol and other polyols), methyl or ethyl esters of any of these alcohols. Other products include methyl acrylate, methylmethacrylate, lactic acid, citric acid, formic acid, acetic acid, propionic acid, butyric acid, succinic acid, valeric acid, caproic acid, 3-hydroxypropionic acid, palmitic acid, stearic acid, oxalic acid, malonic acid, glutaric acid, oleic acid, linoleic acid, glycolic acid, γ-hydroxybutyric acid, and mixture thereof, a salt of any of these acids, or a mixture of any of the acids and their respective salts. a salt of any of the acids and a mixture of any of the acids and respective salts.

Other intermediates and products, including food and pharmaceutical products, are described in U.S. Ser. No. 12/417,900 filed Apr. 3, 2009, the full disclosure of which is hereby incorporated by reference herein.

### Carbohydrate Containing Materials

Carbohydrate-containing materials include lignocellulosic, cellulosic and starchy materials. Lignocellulosic materials include, for example, wood, grasses, e.g., switchgrass, grain residues, e.g., rice hulls, bagasse, jute, hemp, flax, bamboo, sisal, abaca, straw, wheat straw, corn cobs, coconut hair, algae, seaweed, and mixtures of any of these. Cellulosic materials include, for example, paper, paper products, paper pulp, materials having a high α-cellulose content such as cotton, and mixtures of any of these. For example paper products as described in U.S. application Ser. No. 13/396,365 the full disclosure of which is incorporated herein by reference. Any of the methods described herein can be practiced with mixtures of any biomass materials described herein.

In some cases, the lignocellulosic material includes corncobs. Ground or hammermilled corncobs can be spread in a layer of relatively uniform thickness for irradiation, and after irradiation are easy to disperse in the medium for further processing. To facilitate harvest and collection, in some cases the entire corn plant is used, including the corn stalk, corn kernels, and in some cases even the root system of the plant.

Advantageously, no additional nutrients (other than a nitrogen source, e.g., urea or ammonia) are required during fermentation of corncobs or cellulosic or lignocellulosic materials containing significant amounts of corncobs.

Corncobs, before and after comminution, are also easier to convey and disperse, and have a lesser tendency to form explosive mixtures in air than other cellulosic or lignocellulosic materials such as hay and grasses.

Other biomass materials include starchy materials and microbial materials.

Starchy materials include starch itself, e.g., corn starch, wheat starch, potato starch or rice starch, a derivative of starch, or a material that includes starch, such as an edible food product or a crop. For example, the starchy material can be arracacha, buckwheat, banana, barley, cassava, kudzu, oca, sago, sorghum, regular household potatoes, sweet potato, taro, yams, or one or more beans, such as favas, lentils or peas. Blends of any two or more starchy materials are also starchy materials. Mixtures of starchy, cellulosic and or lignocellulosic materials can also be used. For example, a biomass can be an entire plan, a part of a plant or different parts of a plant e.g., a wheat plant, cotton plant, a corn plant, rice plant or a tree. The starchy materials can be treated by any of the methods described herein.

In other embodiments, the biomass materials, such as cellulosic, starchy and lignocellulosic feedstock materials, can be obtained from plants that have been modified with respect to a wild type variety. Such modifications may be, for example, through the iterative steps of selection and breeding to obtain desired traits in a plant. Furthermore, the plants can have had genetic material removed, modified, silenced and/or added with respect to the wild type variety. For example, genetically modified plants can be produced by recombinant DNA methods, where genetic modifications include introducing or modifying specific genes from parental varieties, or, for example, by using transgenic breeding wherein a specific gene or genes are introduced to a plant from a different species of plant and/or bacteria. Another way to create genetic variation is through mutation breeding wherein new alleles are artificially created from endogeneous genes. The artificial genes can be created by a variety of ways including treating the plant or seeds with, for example, chemical mutagens (e.g., using alkylating agents, epoxides, alkaloids, peroxides, formaldehyde), irradiation (e.g., X-rays, gamma rays, neutrons, beta particles, alpha particles, protons, deuterons, UV radiation) and temperature shocking or other external stressing and subsequent selection techniques. Other methods of providing modified genes is through error prone PCR and DNA shuffling followed by insertion of the desired modified DNA into the desired plant or seed. Methods of introducing the desired genetic variation in the seed or plant include, for example, the use of a bacterial carrier, biolistics, calcium phosphate precipitation, electroporation, gene splicing, gene silencing, lipofection, microinjection and viral carriers. Additional genetically modified materials have been described in U.S. application Ser. No 13/396,369 filed Feb. 14, 2012 the full disclosure of which is incorporated herein by reference.

Microbial materials include, but are not limited to, any naturally occurring or genetically modified microorganism or organism that contains or is capable of providing a source of carbohydrates (e.g., cellulose), for example, protists, e.g., animal protists (e.g., protozoa such as flagellates, amoeboids, ciliates, and sporozoa) and plant protists (e.g., algae such alveolates, chlorarachniophytes, cryptomonads, euglenids, glaucophytes, haptophytes, red algae, stramenopiles, and viridaeplantae). Other examples include seaweed, plankton (e.g., macroplankton, mesoplankton, microplankton, nanoplankton, picoplankton, and femptoplankton), phytoplankton, bacteria (e.g., gram positive bacteria, gram negative bacteria, and extremophiles), yeast and/or mixtures of these. In some instances, microbial biomass can be obtained from natural sources, e.g., the ocean, lakes, bodies of water, e.g., salt water or fresh water, or on land. Alternatively or in addition, microbial biomass can be obtained from culture systems, e.g., large scale dry and wet culture systems.

### Saccharifying Agents

Suitable cellulolytic enzymes include cellulases from the genera Bacillus, Pseudomonas, Humicola, Fusarium, Thielavia, Acremonium, Chrysosporium and Trichoderma, and include species of Humicola, Coprinus, Thielavia, Fusarium, Myceliophthora, Acremonium, Cephalosporium, Scytalidium, Penicillium or Aspergillus (see, e.g., EP 458162), especially those produced by a strain selected from the species Humicola insolens (reclassified as Scytalidium thermophilum, see, e.g., U.S. Pat. No. 4,435,307), Coprinus cinereus, Fusarium oxysporum, Myceliophthora thermophila, Meripilus giganteus, Thielavia terrestris, Acremonium sp., Acremonium persicinum, Acremonium acremonium, Acremonium brachypenium, Acremonium dichromosporum, Acremonium obclavatum, Acremonium pinkertoniae, Acremonium roseogriseum, Acremonium incoloratum, and Acremonium furatum; preferably from the species Humicola insolens DSM 1800, Fusarium oxysporum DSM 2672, Myceliophthora thermophila CBS 117.65, Cephalosporium sp. RYM-202, Acremonium sp. CBS 478.94, Acremonium sp. CBS 265.95, Acremonium persicinum CBS 169.65, Acremonium acremonium AHU 9519, Cephalosporium sp. CBS 535.71, Acremonium brachypenium CBS 866.73, Acremonium dichromosporum CBS 683.73, Acremonium obclavatum CBS 311.74, Acremonium pinkertoniae CBS 157.70, Acremonium roseogriseum CBS 134.56, Acremonium incoloratum CBS 146.62, and Acremonium furatum CBS 299.70H. Cellulolytic enzymes may also be obtained from Chrysosporium, preferably a strain of Chrysosporium lucknowense. Additionally, Trichoderma (particularly Trichoderma viride, Trichoderma reesei, and Trichoderma koningii), alkalophilic Bacillus (see, for example, U.S. Pat. No. 3,844,890 and EP 458162), and Streptomyces (see, e.g., EP 458162) may be used.

### Fermentation Agents

The microorganism(s) used in fermentation can be natural microorganisms and/or engineered microorganisms. For example, the microorganism can be a bacterium, e.g., a cellulolytic bacterium, a fungus, e.g., a yeast, a plant or a protist, e.g., an algae, a protozoa or a fungus-like protist, e.g., a slime mold. When the organisms are compatible, mixtures of organisms can be utilized.

Suitable fermenting microorganisms have the ability to convert carbohydrates, such as glucose, fructose, xylose, arabinose, mannose, galactose, oligosaccharides or polysaccharides into fermentation products. Fermenting microorganisms include strains of the genus Sacchromyces spp. e.g., Sacchromyces cerevisiae (baker's yeast), Saccharomyces distaticus, Saccharomyces uvarum; the genus Kluyveromyces, e.g., species Kluyveromyces marxianus, Kluyveromyces fragilis; the genus Candida, e.g., Candida pseudotropicalis, and Candida brassicae, Pichia stipitis (a relative of Candida shehatae, the genus Clavispora, e.g., species Clavispora lusitaniae and Clavispora opuntiae, the genus Pachysolen, e.g., species Pachysolen tannophilus, the genus Bretannomyces, e.g., species Bretannomyces clausenii (Philippidis, G. P., 1996, Cellulose bioconversion technology, in Handbook on Bioethanol: Production and Utilization, Wyman, C. E., ed., Taylor & Francis, Washington, D.C., 179-212). Other suitable microorganisms include, for example, Zymomonas mobilis, Clostridium thermocellum (Philippidis, 1996, supra), Clostridium saccharobutylacetonicum, Clostridium saccharobutylicum, Clostridium Puniceum, Clostridium beijernckii, Clostridium acetobutylicum, Moniliella pollinis, Yarrowia lipolytica, Aureobasidium sp., Trichosporonoides sp., Trigonopsis variabilis, Trichosporon sp., Moniliellaacetoabutans, Typhula variabilis, Candida magnoliae, Ustilaginomycetes, Pseudozyma tsukubaensis, yeast species of genera Zygosaccharomyces, Debaryomyces, Hansenula and Pichia, and fungi of the dematioid genus Torula.

Commercially available yeasts include, for example, Red Star®/Lesaffre Ethanol Red (available from Red Star/Lesaffre, USA), FALI® (available from Fleischmann's Yeast, a division of Burns Philip Food Inc., USA), SUPERSTART® (available from Alltech, now Lalemand), GERT STRAND® (available from Gert Strand AB, Sweden) and FERMOL® (available from DSM Specialties).

### Arc Welding

The combined high frequency high voltage current can also be used a power source for Arc Welding. For example Arc welding of oxide forming metals, such as aluminum, require a negative as well as a positive polarization to ensure oxide formation does not provide for a poor weld. One advantage is that high frequency high voltage can be provided to the arc welder remotely through a co-axial cable.

### Inductive Heating

The combined high frequency high voltage current can also be used as a power source for inductive heating applications. This involves heating an electrically conductive object by electromagnetic induction. Generally, an induction heater consists of an electromagnet, through which a high-frequency AC current is passed (e.g., as provided by the power sources described herein). The applications of inductive heating include, for example, welding, soldering, cooking, brazing, sealing and plastic processing. The power source can be provided remotely through a co-axial cable to the various inductive devices.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (e.g., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While this invention has been particularly shown and described with references to preferred embodiments thereof, it will be understood by those skilled in the art that various changes in form and details may be made therein without departing from the scope of the invention encompassed by the appended claims.

What is claimed is:

1. A power supply for producing a combined high frequency high voltage current, the power supply comprising:
an AC input voltage providing a plurality of output phases;
a plurality of AC to DC converters each accepting one of the plurality of output phases;
a plurality of IGBT switching elements each accepting an output of a corresponding one of the plurality of AC to DC converters;
a plurality of high frequency step up elements each accepting an AC voltage output of a corresponding one of the plurality of IGBT switching elements; and
a summation element for combining a high frequency high voltage current output from each of the plurality of high frequency step up elements.

2. The power supply of claim 1 wherein the plurality of output phases include three phases and the plurality of IGBT switching elements include six groups.

3. The power supply of claim 1 further including,
a synchronous pulse generator coupled to the plurality of IGBT switching elements, to provide synchronous switching of the plurality of IGBT switching elements.

4. The power supply of claim 1 further including,
a plurality of DC filtering circuits coupled to the output of each of the AC to DC converters.

5. The power supply of claim 1 wherein the plurality of high frequency step up elements includes an inductively coupled transformer.

6. A power supply method for producing a combined high frequency high voltage current, the method comprising:
providing an AC input voltage having a plurality of output phases to a plurality of AC to DC converters each accepting one of the plurality of output phases and producing a plurality of output DC currents,
providing the plurality of output DC currents to a plurality of IGBT switching elements each accepting the output of a corresponding one of the plurality of AC to DC converters and producing a plurality of output AC currents,
providing the plurality of output AC currents to a plurality of high frequency step up elements each accepting an AC voltage output of a corresponding one of the plurality of IGBT switching elements; and
combining, in series, a high frequency high voltage current output from each of the plurality of high frequency step up elements to produce the combined high frequency high voltage current.

7. The method of claim 6 wherein the high frequency produced is at least about 1 KHz.

8. The method of claim 6 wherein the plurality of output phases includes three phases and the plurality of IGBT switching elements include six groups.

9. The method of claim 6 wherein a voltage of the combined high frequency high voltage current is at least about 2 times a voltage of the AC input voltage.

10. The method of claim 6 wherein a voltage of the combined high frequency high voltage current is at least about 5 times a voltage of the AC input voltage.

11. The method of claim 6 wherein a voltage of the combined high frequency high voltage current is at least about 10 times a voltage of the AC input voltage.

12. The method of claim 6 wherein a voltage of the combined high frequency high voltage current is at least about 50 times a voltage of the AC input voltage.

13. The method of claim 6 wherein a voltage of the combined high frequency high voltage current is at least about 100 times a voltage of the AC input voltage.

14. The method of claim 6 wherein the AC voltage output from any IGBT is stepped up by a factor of at least about 6 in providing the corresponding high frequency high voltage current.

15. A method for processing biomass material, the method comprising;
providing a combined high frequency high voltage current to a particle accelerator,
accelerating a plurality of particles and,
irradiating a biomass material with the accelerated particles.

16. The method of claim 15 wherein the higher frequency is at least about 1 KHz.

17. The method of claim 15 wherein the step for providing a combined high frequency high voltage current further includes,
providing an AC input voltage having a plurality of output phases to a plurality of AC to DC converters each accepting one of the plurality of output phases and producing a plurality of output DC currents,
providing the plurality of output DC currents to a plurality of IGBT switching elements each accepting the output of a corresponding one of the plurality of AC to DC converters and producing a plurality of output AC currents,
providing the plurality of output AC currents to a plurality of high frequency step up elements each accepting an AC voltage output of a corresponding one of the plurality of IGBT switching elements; and
combining, in series, a high frequency high voltage current output from each of the plurality of high frequency step up elements to produce the combined high frequency high voltage current.

18. The method of claim 15 wherein the plurality of output phases includes three phases and the plurality of IGBT switching elements include six groups.

19. The method of claim 15 further comprising irradiating the biomass with at least about 0.25 Mrad.

20. The method of claim 15 wherein the particle accelerator comprises an electron beam accelerator.

21. The method of claim 20 wherein the electron beam accelerator has an operating power of at least about 5 KW.

22. The method of claim 20 wherein the electron beam accelerator has an operating efficiency of at least about 60%.
